(19) United States
(12) Patent Application Publication
(10) Pub. No.: US 2011/0029398 A1
(43) Pub. Date: Feb. 3, 2011

(54) Geo name service for validated locations and occupants and URLs

(76) Inventor: Wesley John Boudville, Perth (AU)

Correspondence Address: Wesley Boudville, 818 N. Hill Street #536, Los Angeles, CA, 90012, US

(21) Appl. No.: 12/658,724

(22) Filed: Feb. 16, 2010

Related U.S. Application Data
(60) Provisional application No. 61/273,050, filed on Jul. 31, 2009.

(51) Int. Cl. G06Q 30/00; G06F 17/30; G06F 21/00; G06F 15/16; G01C 21/00

(52) U.S. Cl. 705/26.1; 726/26; 707/769; 709/206; 700/300; 707/E17.014

(57) ABSTRACT

We define a Geo Name Service (GNS) that maps from a location query to a geographic region that contains the location and, in turn, to verified owners and occupants of that region, where these entities could be persons or organisations. The GNS then returns URLs of websites or data feeds (Web Services), email addresses, Instant Messaging addresses, phone numbers and other data associated with the entities. The GNS can associate locations with the Internet and Web in a reliable manner, and it enables value added computing and electronic commerce. The GNS can disambiguate references to individuals in web pages, using “person URLs” and “person files”. A person URL is a URL at the GNS that represents a given location and a person living or working at that location. A person file has one or more maps from a text string that represents a person's name in a page at some URL to a person URL that refers to a specific person at a specific location.

### CROSS REFERENCE TO RELATED APPLICATION

This application claims the benefit of the filing date of U.S. Provisional Application, No. 61/273,050, “Geo Name Service for validated locations and occupants and URLs”, filed Jul. 31, 2009. That Application is incorporated by reference in its entirety.

### REFERENCES CITED

[The Web references are as of June 2009.]

akamai.com

amazon.com

arin.net

craigslist.org

cybertrust.com

del.icio.us

earthquake.usgs.gov/research/monitoring/anss

en.wikipedia.org/wiki/AGPS

en.wikipedia.org/wiki/Air_rights

en.wikipedia.org/wiki/Beidou_navigation_system

en.wikipedia.org/wiki/Extended_Validation_Certificate

en.wikipedia.org/wiki/Folksonomy

en.wikipedia.org/wiki/Geocoding

en.wikipedia.org/wiki/Geographic_information_systems

en.wikipedia.org/wiki/Geotagging

en.wikipedia.org/wiki/GPS

en.wikipedia.org/wiki/GLONASS

en.wikipedia.org/wiki/Link_farm

en.wikipedia.org/wiki/Object_Naming_Service

en.wikipedia.org/wiki/Short_message_service

en.wikipedia.org/wiki/Multimedia_Messaging_Service

en.wikipedia.org/wiki/Web_service

facebook.com

flickr.com

google.com

json.org

mail.yahoo.com

microformats.org/wiki/geo-waypoint-examples

myspace.com

verisign.com

w3.org/RDF

zillow.com

“Desktop GIS: Mapping the Planet with Open Source Tools” by G. Sherman, Pragmatic 2008, ISBN 978-1934356067.

“Kicking Reality Up a Notch” by L. Berlin, NYTimes 11 Jul. 2009.

“Mashups” by J. Hanson, Addison-Wesley 2009, ISBN 978-0321591814.

“Phishing and Countermeasures: Understanding the Increasing Problem of Electronic Identity Theft” by M. Jakobsson and S. Myers, Wiley 2006, ISBN 0471782459.

“RFID Applied” by J. Banks et al, Wiley 2009, ISBN 978-0471793656, p. 227.

“Security Analysis of the Object Naming Service” by B. Fabian et al, Humbolt University, Berlin, May 2005.

“SOA Using Java Web Services” by M. Hansen, Prentice-Hall 2007, ISBN 978-0130449689.

“Stopping Spam” by A. Schwartz and S. Garfinkel, O'Reilly 1998, ISBN 156592388X.

“Understanding GPS, Principles and Applications” by E. Kaplan et al, Artech 2006, ISBN 978-1580538947.

“Multi-Dimensional Reputation Scoring” by Alperovitch et al, US Provisional Application 20080175266.

“Methods for Interaction, Sharing, and Exploration over Geographical Locations” by Chen et al, US Provisional Application 20070233367.

“Methods and apparatus for identifying asset location in communication networks” by Goren et al, U.S. Pat. No. 7,250,906.

“Mapping Network Addresses to Geographical Locations” by Guo et al, US Provisional Application 20090100005.

“Method to remotely geolocate and activate or deactivate valuable equipment” by Jandrell, U.S. Pat. No. 7,210,164.

“System and method for determining location of a device in a wireless communication network” by Joshi, U.S. Pat. No. 7,215,966.

“Personal Points of Interest in Location-Based Applications” by Ju et al, US Provisional Application 20090082037.

### TECHNICAL FIELD

The invention relates to the use of cellphones and other mobile wireless computers and to the definition and use of validated geocoded information.

### BACKGROUND OF THE INVENTION

In recent years, the usage of cellphones has grown tremendously all over the world. If we consider a cellphone as a computer, then it is the most common personal computer owned on a global scale. Most of the use has been to make and receive audio calls. Increasingly, however, there have been new usages. One major use is surfing the Web, where the phone has a web browser. Another use is to send and receive text messages. Currently, these are SMS (Short Message Service) messages. But there could be in the future the use of MMS (Multimedia Messaging Service). These extend SMS to include other types of non-textual content, like images.

Another trend has been the increasing ability of a cellphone to know its own location. Typically this might be done by the cellphone having GPS circuitry, that let it use signals from a constellation of satellites. This geolocation ability could be also done or supplemented by signals from terrestrial base stations. One US implementation is known as “assisted GPS” (aGPS).

Once a cellphone has geolocation ability, then the prospect of location sensitive usages arise. There has been much speculation and activity in this regard. One example is where a user might get ad messages, perhaps with directions to a nearby shop. These messages could be in response to the user asking the cellphone for a shop that might sell a certain type of good.

Such activities involve the development of a geocoding database, where there is a mapping from something like an address location to geographic coordinates like latitude and longitude. The mapping might typically involve a third type of data, like information about that location; e.g. is it a shop?, what type of shop? etc. It might be this latter data that gives the database its most utility.

Closely related is the idea of reverse geocoding, where one starts from geographic coordinates and gets some kind of textual street address.

It should be noted that the above usages of a cellphone have some manual operation by the user. In this sense, these are akin to the common use of a web browser on a personal computer to browse the Web. (And of course above, we explicitly cited the case of a cellphone being used to browse the Web.)

But the Web can be used for more than manual browsing, through the invocation of Web Services. (Cf. “SOA Using Java Web Services” by M. Hansen, Prentice-Hall 2007, ISBN 978-0130449689”.) These allow the programmatic offering and use of data feeds, where a data feed is available at some Internet address (including port number) and format type (often XML).

Another phenomenon is geotagging. For example, a photo might be taken, perhaps from a cellphone's camera, or from a (digital) camera, where the photo is stored in digital form on a user's computer, along with the geographic coordinates of where it was taken, and possibly with the azimuth and elevation with which it was taken. Various data storage formats exist (cf. wikipedia.org/wiki/Geotagging). At least currently, the data is often used in websites that have these photos, and which give some information about where there photos were taken. E.g. flickr.com and del.icio.us.

The geolocation information lets the data be searched for entries about or around some location. Related to this is the building of a database table, where, essentially, the key is a location (in some format) and the value is a set of commentaries about that location. These commentaries are geographic markup, where the commentaries might be contributed from anyone, sometimes called a folksonomy.

One possible usage of the folksonomy is via the use of special spectacles. These are connected to the above database in a wireless manner. As the wearer moves around some region, she sees both the actual image of the surroundings, overlaid with tag information about those objects. In distinction to a Virtual Reality Markup Language for an artificial 3 dimensional world, this might be construed as an augmented reality implementation. While prototypes of such spectacles have been built, there has been no mass market. But as the capabilities increase, the mass decreases and the cost decreases, they might become common.

Consider “Mapping Network Addresses to Geographical Locations” by Guo et al, US Provisional Application 20090100005. It depends in large part on the analysis of webpages, to try to parse out a location from the contents. Our invention does not parse webpages for location information. Also, they do not have any applications specific to mobile computers. They do not have or use any authoritative data to associate a location with ownership or occupancy. Their methods for parsing a webpage are very heuristic and rough. If a series of webpages only give an address (whether this is true or not) that has a fine grained resolution of a town's name, then this is the limit of the method's resolution. Our method can give meter (or submeter) resolution.

Consider “Personal Points of Interest in Location-Based Applications” by Ju et al, US Provisional Application 20090082037. They do not find authoritative data to associate a location with ownership or occupancy.

Consider “Multi-Dimensional Reputation Scoring” by Alperovitch et al, US Provisional Application 20080175266. They (try to) do geolocation based authentication of a person trying to login to a financial website. But this is stochastic. Essentially, they are seeing if the person is logging in from a neighbourhood consistent with previous logins. Our method is deterministic. Nor do they authoritatively associate a business with a fixed location.

Consider the Regional Internet Registries, like arin.net. These maintain a mapping from IP address to location. But in general these registries do not guarantee the authenticity or accuracy of such mappings.

Consider “Methods for Interaction, Sharing, and Exploration over Geographical Locations” by Chen et al, US Provisional Application 20070233367. It mostly concerns the building of a folksonomy of tagging of real world objects in a virtual representation. There is no concept of authenticating the owner or occupant of a physical location.

Consider “Methods and apparatus for identifying asset location in communication networks” by Goren et al, U.S. Pat. No. 7,250,906. There are several differences with us. First, the assets in Goren are often assumed to be mobile. We deal mostly with entities (assets) at fixed locations. Second, Goren's assets have active tags which can be detected by transceivers. Our entities need not have tags or be detectable by a wireless network.

Consider “System and method for determining location of a device in a wireless communication network” by Joshi, U.S. Pat. No. 7,215,966. The device is mobile and can communicate on the wireless network. We deal mostly with entities at fixed locations, and our entities need not be able to communicate wirelessly.

Likewise, consider “Method to remotely geolocate and activate or deactivate valuable equipment” by Jandrell, U.S. Pat. No. 7,210,164. The equipment is assumed to have wireless communication ability. Nor does the equipment refer to a business or individual, and the activating or deactiving is not germane to our invention.

Consider Google Inc.'s Google World. This is used in a web browser, where the user types in a street address in some city (often in the US). A webpage might then appear, showing a picture of the building at that address. One limitation, as far as we can ascertain, is that there is no, or little, further information about that building and its occupants. Another limitation is that the input is restricted to a street address, instead of a location, given perhaps in latitude and longitude, within that land plot.

Consider the Object Name Service (ONS). (Cf. “Security Analysis of the Object Name Service” by B. Fabian et al, Humboldt University Berlin, May 2005; “RFID Applied” by J. Banks et al, ISBN 9780471793656, p. 227.) This is analogous to the Domain Name Service. It maps from a globally unique RFID to a computer server that has information about the item with that id. There are 3 differences with this invention. First, the ONS items have RFID tags. The “items” in this invention do not have to have RFID tags. Second, the ONS items are mobile, in general. The ONS items are typically products that move through a manufacturing, supply, retail and end user chain, and are at different locations. In this invention, the “items” are locations or entities associated with those locations. Third, the ONS items are typically products. In this invention, the “items” are locations or entities associated with those locations, where typically the entities are persons or companies.

The above patent applications and patents are all expressly incorporated herein by reference.

Broadly speaking, much of the prior art concerning geolocation involves extending the reach and resolution of such a service, with little, if any, dealing with authenticated associations between a location and an entity at that location, where the entity is typically fixed. To the extent that prior art looks at a location and an entity, that entity is often a person with a cellphone, who is mobile. Or that entity has some kind of wireless capability, even if this is minimally a physical tag (like an RFID tag), that can thus be used by a transceiver to locate the entity.

We make an analogy with the protocol stack in TCP/IP. The lowest layer is the physical layer, on top of which is the data link layer. We compare the prior art to those layers. Whereas, especially for the Web, the value in the Internet is mostly in the higher levels. So too in this invention do we describe higher level applications that build upon a basic geolocation functionality, and that integrate the use of other databases.

### SUMMARY

We define a Geo Name Service (GNS) that maps from a location query to a geographic region that contains the location, and, in turn, to verified owners and occupants of that region, where these entities could be persons or organisations. The GNS then returns URLs of websites or data feeds (Web Services), email addresses, Instant Messaging addresses, phone numbers and other data associated with the entities. The GNS can associate locations with the Internet and Web in a reliable manner, and it enables value added computing and electronic commerce.

The GNS can disambiguate references to individuals in web pages, using “person URLs” and “person files”. A person URL is a URL at the GNS that represents a given location and a person living or working at that location. A person file has one or more maps from a text string that represents a person's name in a page at some URL to a person URL that refers to a specific person at a specific location.

### BRIEF DESCRIPTION OF THE DRAWINGS

FIG. 1 shows Jane using her cellphone to get information from the GNS about a location (x, y).

FIG. 2 shows all the results returned by a search engine for “Mike Wong”, and a splitting of those results by geographic location of specific persons.

FIG. 3 shows how person URLs for Lucy and Ralph, at the web pages of domain Alpha.com, are used to define possible locations for Mike Wong.

FIG. 4 shows Jane using the GNS to test that a transmitter at (x, y) is a real transmitter associated with that location.

FIG. 5 shows how the GNS can give verified location data about a survey's respondents.

### DETAILED DESCRIPTION OF THE PREFERRED EMBODIMENT

What we claim as new and desire to secure by letters patent is set forth in the following claims.

In what follows, we will mostly refer to the use of a cellphone for narrative convenience. This can be generalised to include the use of any wireless computer, like a PDA, laptop, smartphone or netbook. Typically this wireless computer may be used in a mobile context, where it is carried by its user, who moves around some geographic region. It has the ability to connect to at least one type of wireless network. The latter might include Bluetooth, WiFi, WiMax, paging, Personal Communication System and cellular. (Though by definition, when we speak of a cellphone, it uses at least a cellular phone network.)

Also, we refer to GPS as one source of geolocation information. This is a particular constellation of satellites run by the US Federal government. Globally, it is the most commonly used system of satellites for geolocation. But in general, our usage of GPS should be construed as encompassing any other existing and future constellation of satellites and corresponding usage scheme than can be used for geolocation. Including but not limited to Russia's GLONASS, China's Beidou and Europe's Galileo. Our usage of GPS also includes combining data from different constellations of satellites, where this combining might be to improve spatial resolution or faster response time.

The use of GPS might include ground based pseudolites, which augment the reach and accuracy. The cellphone can also get geolocation information from its cellular network of base stations. This might be combined with GPS data for better resolution.

In some contexts, to be mentioned later, there might not be cellular coverage. Then, the term cellphone should be construed as meaning a mobile device that possibly uses satellites for communication (“satphone”), as well as for geolocation. Note that in this case, there could be 2 satellite systems used; one for communication and one for geolocation.

Our Invention has These Sections
1a. Base Geo Name Service
1b. Extensions of Email
1c. Extensions of Browsing
1d. Symmetry Breaking (Removing Degeneracy)
1e. Person File
1f. Sorting Search Results for Persons
1g. Geographic Maps of Domains
1h. Personal History File
2. Government Implementation
3. Alternatives
4. Uniqueness
5. Vertical Extension
6. International Territory
7. Non-Commercial Uses
8. Custom Tags
9. Data Collection
10. User Interface
11. Advertising Rights and Licensing
12. Mobile Locations
13. Identity and Image Validation
14. Extended Analysis
15. Inventory Listings and Control
16. Hardware
17. Feedback Ratings
18. Demographic Surveys of Location
19. Application Programming Interface (API)
20. Searching
21. Digital Storage
22. No GNS
23. Other Usages of a Person File

1a. Base Geo Name Service

Consider the use of a cellphone by a typical user, Jane. It is assumed to have geolocating ability, which could involve using GPS or various location methods involving the cellular base stations. She is at some location and she asks a simple question. Who rightfully owns this location or operates (i.e. works) or lives at this location? Assume that if there is a business building at the location, it is closed, so she cannot simply walk in. While if there is a residential building, she likewise cannot or is unwilling to enquire directly at the building.

In the real world, to find an authoritative answer for the owner of a location, she would perhaps go to the nearest land registry. This would be run by the government, and lists the owners of land in that region. But there are several problems. First, she has to find out where that land registry exists. The average person might not know this. Then, she has to go there, leaving her current location. Once at the registry, she has to peruse a database and find the plot of land that includes her previous location, or she has to ask (and probably pay) someone at the registry to do this. And the registry might be closed when she arrives.

A partial answer to the above has been implemented by Zillow Inc., a website that shows price histories of houses in the US. On that website you enter a street address, including perhaps the post code and other location data needed for any disambiguation. If Zillow has data on that address, it lists the price history and related data. Zillow and its competitors are useful for their purposes, which are primarily to facilitate a real estate transaction.

Suppose the location is not that of a private residence, but of some government office. In general, these do not [or rarely] change ownership, and Zillow and others of its ilk will likely have no data on them, even in principle.

Jane might have other reasons for her query. Suppose she's not interested in buying the property. Suppose the location is a shop that is currently closed. She might want to query what it is selling. In general, the shop building and land are owned by one party, while the shop business is a tenant. It is the tenant she wants to contact. She might perhaps come back when the shop is open. But she wants to know now if the shop has a computer on some (wireless) network, offering the information she wants. Currently, one way is to peruse the shop front for a website address of the shop. Then, Jane can type this into her cellphone's web browser, assuming the cellphone has this ability, and many increasingly do. Then she can look at the resultant web pages.

But notice the manual steps. She has to search the shop front for a website name. If it exists, she has to type it into her phone. Both steps are error prone. It would be much simpler and more robust if somehow she could point the phone at the shop, and it would bring up the correct website.

An alternative if her phone has Bluetooth is to see if the shop has a Bluetooth transmitter. But it might not. Later, we return to more discussions about Bluetooth.

In the development of the Internet a fundamental operation is the Domain Name Service (DNS), which maps between a raw Internet Protocol address and a corresponding domain name. This was necessary because IP addresses are just strings of numbers, which are hard for people to remember, since they convey little semantic information. DNS arose, in no small part so that people could use domain names, firstly and often in email addresses, and later when the Web arose, in URLs for browsers to display web pages.

What this invention proposes, as a base implementation, is a Service that maps from a geocoded location to one or more authoritative Internet addresses or websites or email addresses or other network addresses for that location. At its core is a Geo Name Service (GNS) that does the following:

| | |
|---|---|
| location (x, y) | ---> site containing (x, y) [A] |
| | ---> owner OR tenants of site [B] |
| | ---> URLs, email addresses and other data [C] |

Here (x, y) stands for coordinates describing a point on the Earth's surface. Typically, these are latitude and longitude, preferably measured down to submeter accuracy if possible. There could be alternative encodings. One of these is a full street address, using the naming conventions or requirements for the country that has that location. So, for example, in the US, a full street address might be “123 Main St, Townsberg Calif. 90000, USA”. Here, there might be valid shorter forms of a full address, where a valid shorter form is any address with fields omitted, but that is still sufficient for the GNS to map to a land site.

Thus, in addition to Jane's cellphone having geolocation ability, it is assumed to be able to wirelessly contact the Internet. Perhaps via the cellphone network. Or it might be via a different network accessible by the cellphone. (E.g. WiFi or WiMax.) The requirements of this paragraph are already present in many cellphones in the US and other countries in 2009.

Another feature of the cellphone, and specific to this invention, is that its software can take a geolocation given by its geolocation hardware and convert this into an Internet query that is then sent out in a wireless manner on the Internet to the GNS. (The format of this query is discussed later.) The previous paragraph described two existing hardware abilities (geolocation and Internet) while this paragraph is about the passing of data between the abilities. Currently a cellphone with geolocation hardware can access that geolocation data and use it in various manners. Hence, it is straightforward to implement another usage of the same data.

We stress that we are not primarily concerned with the cellphone per se, but with what entity (land site, building) is at the cellphone's location. And in general, that entity need not itself have wireless communications ability. Much prior art focuses on mobile objects that have wireless ability, and on geolocating them, which is not the focus of this invention.

Imagine, for now, that (x, y) is on land. The site containing (x, y) is a plot of land, perhaps owned by someone, or perhaps by a government. Step A assumes that a database exists for a region, like a country, that is essentially a land registry. The owners of various plots of land are recorded, along with geofences, which are descriptions of the perimeters of those plots. Step A uses the geofences. Given this, Step A is straightforward to compute. The problem is well defined. Assembling the database for Step A can be done by whatever means external to this invention. Typically, it might be done by a government of a country or region.

Nor does Step A necessarily require all of a nation's land to be in the database. A GNS can be implemented incrementally. Perhaps initially only in some political subdivision, like a state or province. And within that region, only some plots of land might initially be recorded. If (x, y) is not within that database, then Step A ends, and Steps B and C are not done.

Assume Step A gives a particular land site. Step B then involves finding the owner of that land site, plus a list of any current tenants. Clearly, a government amassing the database for Step A would or should also have this information, at least of the owners. In the US, typically tenants do not need to register their locations with the government. In other countries, like China, Germany and France, tenants might be required to do so, or the owners might be required to tell the government who their tenants are.

Steps A and B together are just a simple extension of a traditional land registry. With the added technological feature that the initial query with an (x, y) is input programmatically.

In Step B, the owner or tenant is described in some manner. If the entity is a person, this description might involve sufficient detail to distinguish that person from others in the neighbourhood. At an extreme level, the detail uniquely distinguishes the person from all others in the nation. For this, that detail could involve a driver's license or national id.

Note that if the owner or tenant is a person, we are not talking about real time tracking of that person's location. In general, the person need not have or be wearing any wireless device. While if the entity is a business, it also need not have any wireless device.

Suppose that the nation does not typically sell land, but instead grants long term leases. China, for example. Then the “owner” in step B could be that long term tenant. Who in turn might have short term tenants. In what follows, we will use “owner” in Step B to have this possible extra meaning.

Step C is where for each entity in Step B, there might be corresponding network addresses on some networks. In one implementation, we take a network to be the Internet, and describe the network address as an URL. So Step C returns, in part, a set of URLs. Of course, Step C could return no results, in which case the steps in this invention terminate. In what follows, we assume that Step C returns at least 1 result. The URLs could be of the person's home pages on various domains, where the latter might be social networks. The URLs could also be domains owned by the person.

Step C could also return email addresses, Instant Messaging addresses and phone numbers. These are also addresses on electronic networks. These types of addresses are for making and receiving messages. Whereas the URL-type addresses are for browsing.

Step C could also return, for a given entity, other sites where that entity is also an owner or occupant.

The network addresses in Step C could also include those for users at auction sites (e.g. eBay Inc.), book sellers (e.g. Amazon Inc.) and other commercial sites. It could be advantageous for a user at such a site to be able to affirm a physical location, if she is taking part in transactions and wants or needs to reassure the other party about her identity. This could be a competitive edge over other users at the site, who do not provide such verification.

If the entity has an Internet address, then there are several things to note. First, the entity's connection to the Internet does not have to be a wireless connection. While Jane is using her cellphone to wirelessly connect to the cellphone network, in general that is entirely separate from how the entity at Jane's location connects to the Internet.

Plus, the connection that the entity has to the Internet need not physically be at the entity's location. The association between the entity and its network address is a logical association and not a physical association. Though of course the latter could be true in any specific instance.

Having noted this, the GNS might have some description setting when it returns data in Step C that indicates whether an entity's network address has a location different from the input location to Step A. Optionally the GNS might also give the location of the entity's network address.

If Step C returns an Internet address actually at the site, then this improves upon the accuracy of the common practice of mapping IP addresses to a location. There, the usual meaning of the location is that of an Internet Service Provider, and not of its customers' locations.

The result of Internet addresses at the site can also include estimates of the up and down bandwidths, if that data is available. Here, also, an expectation is that the entity at the site uses one or more static addresses.

For off-site network access, suppose the entity is a person with her own website, and that at her location, she has no computer. She might go elsewhere, to cybercafes perhaps, to log into her website. The location of the website might thus be the location of her upstream ISP or NSP that physically hosts her website.

Step C could also return other descriptive data about each entity. If the entity is a business, this might include a business registration number or license number, if this exists. For individuals, it might also return any licenses they have, e.g. if they are doctors or dentists.

The simplest way to think of a given result is to imagine that it is a website. More generally, an URL could describe a data feed. This might be implemented as a Web Service.

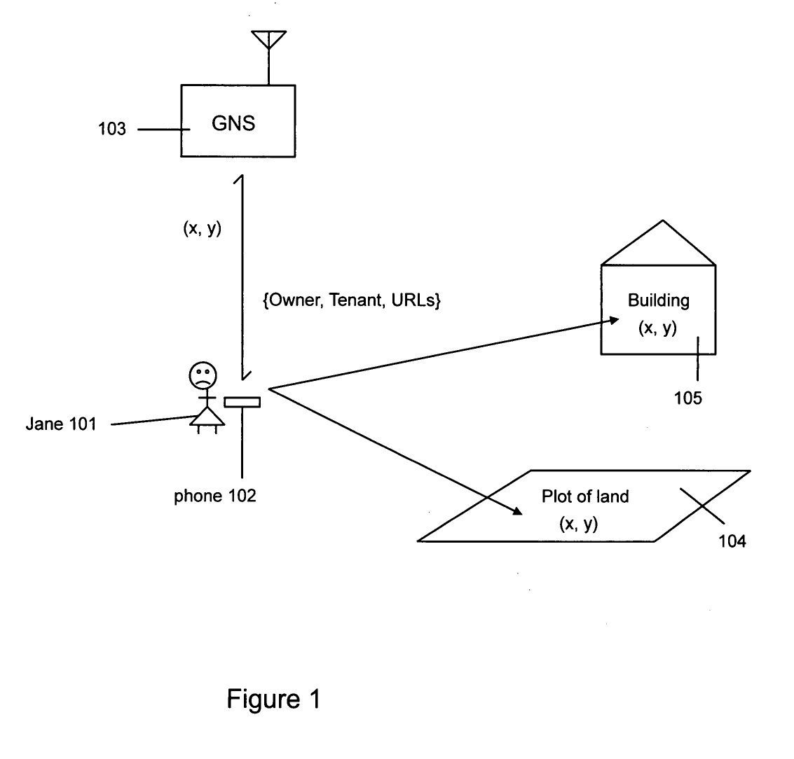

FIG. 1 shows Jane 101 with her cellphone 102. She is at or near a plot of land 104 or a building 105. The coordinates (x, y) of a point in that location are assumed to be obtained by the cellphone, via perhaps GPS, where GPS is not shown explicitly in the figure. The phone then transmits (x, y) (and perhaps other data not shown) wirelessly to the GNS 103. The wireless transmission is meant to be indicated by the antenna symbol on 103. The GNS then downloads data to the phone, including one or more of the owner, tenant/s and URLs associated with (x, y).

A network address in Step C in general could point to a destination controlled by that entity. For simplicity, let the entity be a person. If the network address is a phone number, then she, or someone associated with her, will answer that number. Likewise if the network address is an Instant Messaging address. If the network address is an URL that points to a web page, then she has (or is presumed to have) write privileges on that page.

Another possibility is where the entity does not control whatever is at that network address. If it points to a web page, or to an entire Internet domain, that could be a page or domain of interest to the entity, but not under its control. In this special but important case, there might be an indication when the GNS returns the results, that designates such results as being outside the entity's control. This lets an entity exhibit a personal interest in a topic or to offer advertising “space”.

The page returned by the GNS for the entity could have ads determined by the GNS. The choice of ads could be determined in part by the location. An auction could be used to find ads that will be shown.

Above, when we described the results returned in Step C, the results in Step B could also preferably be returned in response to a query. The query might have optional condition as to whether Step B's results are also desired.

Recall that at the heart of an URL is a network address, given as either a raw IP address or a domain name. Earlier, we described how a fundamental enabler of the Internet is DNS, that maps IP address <----> domain.

Our Steps A-C can be roughly considered as geographic location <----> domain. There are differences. Every active domain must map to at least one IP address. (For redundancy, a domain might have several IP addresses.) While in this invention only some domains will map to a geographic address. That is, an arbitrary domain need not have a geographic meaning or association. This is one way that our invention can be incrementally retrofitted into the existing Internet and Web. The vast majority of existing domains, after an implementation of this invention, can remain unchanged. This also applies to existing URLs that describe data feeds (aka. Web Services).

One similarity is that in this invention a domain might map to several geographic sites, using the GNS. Here, imagine for example a person who has two houses, at two different addresses. Both are associated with the same website run by that person. Or imagine a company with several offices and warehouses, and with one common website.

On the issue of website, this does not have to be a domain owned by that person, like, e.g. “somewhere.com”. The URL could be of a webpage associated with that person, but which is in a domain owned by a different person or organisation. For example, the URL could be of the person's MySpace page, Friendster page, Facebook page, or some other page on a social network. In those situations, typically two parties can edit the page. The domain owner and the individual who personalises the page.

In Step C, if one of the results is an email address, then this could be verified by standard methods, like the GNS sending an email with a link back to the GNS, where that link has unique content. Then the person can login to the email account, and click the link in the email. When the GNS gets the result, then the person has access to that email account. Likewise for proving that a person has an Instant Messaging address, the GNS could ask for a message from that address.

Note that this does not prove that others do not have access to those accounts.

In Step C, one of the types of data could be images of people associated with the location. With perhaps other identifying information, like a driver's license or passport number.

Hence the GNS can act as a validator of identity, and of associating an identity with a place. Against various types of identity fraud, the GNS can be a deterrent.

The validated visuals may be especially useful in some circumstances. Identity cards can often be forged to varying extents. These might be enough to fool anyone not familiar with these or without access to some authoritative database to check the purported card. The GNS can act as a remote out of channel means of ascertaining that someone is who she says she is. (See Section 13 for a further discussion.)

Steps A-C are (broadly) deterministic. While fraud might never been fully prevented, the verification steps above, and elsewhere in this invention, could be done to a strict level of scrutiny.

Alternatively, the GNS might use various levels of scrutiny, and have some indicator when showing results in Step C, as to these levels for each entity. Here, when an entity has various data associated with it in Step C, different data could have different levels of scrutiny.

Note that in the domain naming scheme, there are country domains. The mapping defined in Steps A-C need not map from an (x, y) to a URL with a domain in that country's top level domain range. That is, an (x, y) in Canada need not map to a domain ending in “.ca”.

Different countries might have different policies about this. Some countries might require that their GNS implementation of this invention only uses domains with that country's code. While others have no such restriction.

Suppose Jane asked the GNS and gave an (x, y) on the perimeter of two or more land sites. In this case, the GNS would return results grouped by land site.

An extension of Step C is for the GNS to be able to return a history of changes that an owner or occupant makes to their furnished information. The query could have an argument that requests these results.

An extension of Step C is for the GNS to be able to return a history of owners and occupants of a site. This could include current contact information for them, if it exists. The query could have an argument that requests these results.

Other types of queries to the GNS, rather than just location, are possible. These are described later.

In Steps A-C, the results given in Step C have thus far been independent of the (x, y) input in Step A, so long as (x, y) mapped to the same site. Alternatively, the owner (or occupant) has the results be a function of (x, y) within the site. For example, imagine a rare tree at some (x1, y1). The owner associates a URL with this location that describes this species of tree. While a rock formation at another region in the site maps to a different URL that discusses its geology.

1b. Extensions of Email

In this section, we discuss alternatives to the GNS returning standard email addresses.

The success and need for DNS rests largely on two “killer apps”. The first was email. DNS lets us send email to dave@somewhere.com, instead of having to send to dave@10.20.30.45. Likewise, the second killer app was browsing. DNS lets us type into the browser http://somewhere.com instead of http://10.20.30.45.

For GNS, consider what the analogous scenarios might be. Look first at email, which is asynchronous electronic messaging. An email address consists of [user]@[network address]. Symbolically, a GNS address could be [user]@[location]. How might location be written or encoded? If it is raw (x, y), then this cannot be usefully remembered. A street location like “12 Anyplace Rd, Somewhere N.Y. 11001” is more easily remembered, though still cumbersome.

A different view is offered if we consider “emailing” to a GNS address via a cellphone. The cellphone is at a location, and Jane has contacted the GNS, which has returned data about the occupant in a window on the cellphone. This data could include a GNS “email address”. In the context, Jane is already at that location, so specifying location in the address [user]@[location] is redundant. Hence the GNS “email address” might be some type of clickable link that says, e.g. “Mike”. By picking this, the software brings up a form where Jane can write the subject and body of a message, just as for standard email. The form can include a place for Jane to type her standard email address.

Thus in Step C, one of the results could be a username (“Mike”) in this GNS “email” addressing scheme.

When Jane sends the message, the cellphone software sends this to the GNS, which is an address on an electronic network. The routing instructions would have the location and the username. It is important her that Jane does not have to explicitly type the location. There is enough information here for the location to be automatically furnished.

Suppose that the GNS has a domain on the Internet, gns.com, and it can accept standard email. When Jane sends the message, the cellphone formats this for a GNS. There might be a convention that the normal email address at the GNS that this is sent to is send@gns.com, for example. The subject field is what Jane specified for the subject. While the body of the message might be in XML, with fields like <To> Mike</To> and <At> [coordinates of location] </At> and the actual text body of Jane's message is in the field <Actual> . . . </Actual>.

The GNS then extracts the fields in the above body. It maps the To and At fields to some standard email address on the Internet of the end recipient, that corresponds to the location in its database, and sends a message to that address.

Clearly, other methods could be devised. But the above is one implementation that should be clear and realisable to a skilled reader.

Hence the cellphone software and GNS combined act as an interface to Internet email. This may be preferable to envisioning some entirely new type of email network. The situation here is different from when Internet email usage became popular in the 90s. Prior to the Web, only few people (by today's standards) had any sort of email, not limited to the Internet email. Most people who use email today have never known any other type of asynchronous electronic messaging. So when email took off in the 90s, it was not replacing any prior electronic system for most users. The situation is not true now, if we try to set up an entirely different email system. So as a practical matter, the GNS email can or should be an interface to Internet mail.

Suppose Jane is not at a location of interest to her, and is surfing the Web and using the GNS to find data about the location. Then the GNS webpage for the location has a messaging form, where the recipient is just a username. Jane types a subject and body of the message and she presses ‘send’. The GNS web server implicitly already knows the recipient's actual email address, and so can construct a conventional email to that address, using what Jane typed for the subject and body.

With Internet email addresses, people often keep a list of contacts. Each contact is an address in the Internet email notation. What is the analogous method for GNS addresses?

Consider the case where someone wants to send an email to a phone number. Suppose the phone number is run by a phone company with the domain phone.com. The notation often chosen by actual phone companies is an address of the form 0001234567@phone.com. Here the “000” is the area code and the other digits are the local number.

Consider the situation of sending to a user at a location, where you are not at that location with your cellphone, and you are not at a GNS webpage for that location. There might be some format like user-location@gns.com. Where “location” is in turn defined to have subfields. Here, the location might be x-y where these are latitude and longitude, separated by a dash sign.

Notice also that current Internet mailing systems often let a user define a nickname as an alias for an email address. So she does not have to remember the latter. Likewise, the use of a nickname for a GNS address would alleviate any problems in remembering the latter.

There could or will be different GNS systems, divided by geography. Each might have its own Internet domain, e.g. gns.ca for Canada and gns.com.cn for China. If we imagine gns.com to be the global GNS address, then the server at this address can then route to various national GNSs. Or, of course, a user could send directly to a national GNS.

In terms of a nickname of a GNS address, where the nickname is stored in a user's address book, one possibility is an image. An occupant at a location could define such an image to the GNS, at part of the data about the occupant given in Step C. The GNS then makes it available to end users as a memory aid. The image might be of the occupant, or of the location.

But just as a user typically writes a nickname for an email address, with no input from that address, so too is this possible for images. The mailer could have software that lets the user upload an arbitrary image and associate it with a GNS address.

Also, consider when the user is at or near the location with her cellphone. If the phone has a camera, she can take a photo and use this as her nickname for the GNS address. It is well known that people can better recognise images than text. And in this case, it is especially relevant, because she was at a location and took the photo. Which increases the chance that it will be more memorable to her in her address book.

1c. Extension of Browsing

For browsing, the GNS does not try to replace the Web, but instead supplies a different and dense weaving from location to URL, and from (location+person) to URL. Consider what the analog of browsing would be when we have a GNS.

To show the data from Steps A-C could require a generalised browser in the cellphone, and a corresponding server at the GNS that serves up the browser's requests. The server could be a modification of a standard web server. Imagine a site of land being shown in this browser, as the result from Step A or a combination of Steps A and B. The address of the page (the “URL”) perhaps has its argument being the geofence, where the domain in the address is the GNS domain; i.e. conceptually the URL might be written as “http://gns.com/[geofence]”, where [geofence] indicates that the geofence is written in some encoding format compatible with existing rules for URL contents.

The contents of the page addressed by this URL could show a map of the land and its contiguous neighbours. The resolution and types of data in the map could vary according to different instances of sites being shown. Topography might be displayed. Buildings, streams, fences, paths, power lines, underground pipes etc might be displayed.

Apart from map data, the page might also show a history of the owners and transaction prices. The current owner and occupants would preferably be shown, as clickable links.

The page might be written in HTML or variants like XHTML, and have the usual ability to include external CSS files. This lets the generalised browser use the display methods of the standard browser.

One possible problem with using the geofence as the URL is the limitation on the maximum length of an URL for a standard browser. So alternatively, the argument might simply be the input (x, y) to Step A, where this is written in the suitable URL character range, e.g. “http://gns.com/x= . . . &y= . . . ”. If so, there is now a difference from normal mappings of a URL to a page. In general, the latter has every page with a unique URL describing its location on the Web. In our situation, a page for a site of land has many URLs, where the range of these is the range of all possible (x, y) coordinates in that site, measured in the maximum possible resolution. And this resolution could change (presumably improve) over time.

Simply put, the GNS makes a standard web page for each site in its database.

Now suppose we click on an owner or occupant link in the page. The link might be written using a different protocol. For example, “entity://gns.com/ . . . ”. Though perhaps an implementation might avoid the need for this, and just use the standard “http://gns.com/ . . . ”. Both are possible, though the latter might be preferable simply for compatibility with existing usages.

What does the address of one of these entities mean? Suppose the URL does not contain any information about the site that the entity is in. Then the address could be some unique identifier of that entity. Perhaps unique across the nation in which the site is located. A problem arises if the latter is the case, and the identifier is some widely used identifier for the person in that country. In the US, this might be a Social Security Number, for example. The danger is if this generalised browser is available to the public, data from it might be used for identity fraud.

An alternative is simply to use the person's full name, even though this can result in some ambiguities. This has the benefit that original databases from which the GNS is derived might not have much more than this, associated with a given site.

Another alternative is the full name plus date of birth, if the latter is available.

From a database standpoint, if a person's link has a full name (perhaps with a date of birth), then to handle cases of other sites linking to a person of the same id, the database would generate some internal id or key to separate these cases, if nothing else can be imputed about the persons.

Now suppose that the URL has information within it that designates the site where the owner or occupants are from. As with the page for the site, the URL might have the original (x, y) input from Step A, along with an identifier of the entity who was clicked on. Here, the identifier is much simpler. It only needs to uniquely pick that entity from all the entities with links in that calling page. So we might have an address like “http://gns.com/x= . . . &y= . . . &id=Prakash&id2=Malik”, where the person at the site is called “Prakash Malik”.

Clicking on this gives a page for an entity, which we take to be a person, without loss of generality. The page can have the information described in Step C. Any URLs now have the conventional interpretation, and clicking on these has the browser act like a standard browser.

So the GNS makes an autogenerated web page for every person or company at a site. Call the address of this a “person URL”. We consider this to include the case when the entity is a company or organisation.

The person URL can be generalised to have an extra input argument (or arguments) which designates a time or range of times. This handles the case when we refer to a previous time period when an individual was at a location.

Also, a person's page at the GNS can have a link to another site where she is an owner or occupant. This link might have the geofence or (x, y) encoding discussed above. In this instance, and in general for the GNS page about a person, the GNS should validate as many fields as possible.

One minor extension is where the page for the site can also include links to conventional web pages, where these links are associated with subregions of the site.

Thus the generalised browser lets the user go back and forth between investigating different types of data.

Here we deliberately extended the conventional browser metaphor of display and usage, to include the ability to handle two other types of data. It may be that the shoehorning of those data into the metaphor is not the only way of interacting with the data. But we chose it here because the usage of a conventional browser is now effectively axiomatic amongst many users.

An alternative, in addition to and not exclusive to the above, is where the GNS itself provides a data feed. Consider the discussion in this section and how we went from an input (x, y) to two types of pages, one for a site and one for an entity (person) at the site. It should be clear that if we remove the markup tags from the pages, and format the pages as XML, using some published XML tags, then this becomes a data feed suitable for downstream custom processors that can perform arbitrary operations on the data. And the queries to the GNS might only need an extra boolean argument that specifies whether the results should be content for a Web browser or a data feed. This permits a “mashup” approach akin to what was offered recently by companies like Google Inc. and Yahoo Inc., where they opened up some of their databases via Web Service data feeds. (Cf. “Mashups” by J. Hanson, Addison-Wesley 2009, ISBN 978-0321591814.

Return now to the start of Section 1 a, when we spoke of Jane being at a location with her cellphone and asking the simple question of who owns or lives here? In this section, consider now when one browses the Web. When you see a page that refers to a location, in general, it will be in a “free format”. To the extent that the reference has a link, that link could be to anything (perhaps) associated with the location. The link could be to an arbitrary domain, with a page about the location. Now with the existence of a GNS and a location URL of validated data in a standard form, it lets page authors link to an objective location and associated description of the location. There is no ambiguity.

Of course, authors cannot be compelled to use the GNS location URLs. But the existence of the new capability can generate many usages.

A browser might be modified to store GNS addresses as bookmarks. Possibly, an image might be associated with each, as a mnemonic. The image could be supplied by the occupant, by the GNS or taken by Jane. The GNS might consider supplying an image of a site, because then it can validate that the image is actually of the site. Another reason is if the occupant or owner does not supply an image. But if an image is supplied by the latter parties, the GNS might or might not have steps to validate the accuracy of it.

As for Jane supplying her own image of a site, there is nothing the GNS can do about controlling this. That image would be held on Jane's mail server, which in general is entirely separate from the GNS.

1d. Symmetry Breaking (Removing Degeneracy)

We now consider usages of the “person URL” in more detail. Imagine someone called Mike Wong. If we use a search engine to look for this string, many results would be returned for such a common name, and refer to many people by that name. Such people are sometimes called “Googlegangers”. Which specific person does a specific web page refer to? An alternative and simpler view of the problem is to imagine 2 web pages, with each having the string “Mike Wong”. The pages are at different domains. Is this the same person?

Currently there seem to be no or few programmatic ways to do so. One would have to read (i.e. use “wetware” on) each page, and (try to) understand it, and thence decide using many wetware heuristics which pages refer to the same person. It is a limitation of the current Web that is obvious once described.

As an analogy that may be useful, consider a display of the search results in a bar graph, with the y axis in the vertical direction and the x axis in the horizontal direction. The bars in the graph go in the x direction. Each bar is at a given y value, where this represents a particular Mike Wong. And we have the special case of the y=0 bar as all the search results for Mike Wong. The value of the bar in the x direction is the number of results. The “degeneracy” is a term from physics. Here it refers to the values for the y=0 bar, for all the search results. Initially, all the results are in the y=0 bar, and this can be considered a “symmetry”. The task is to “break” this symmetry by moving as many of the results as possible onto bars for specific and different Mike Wongs.

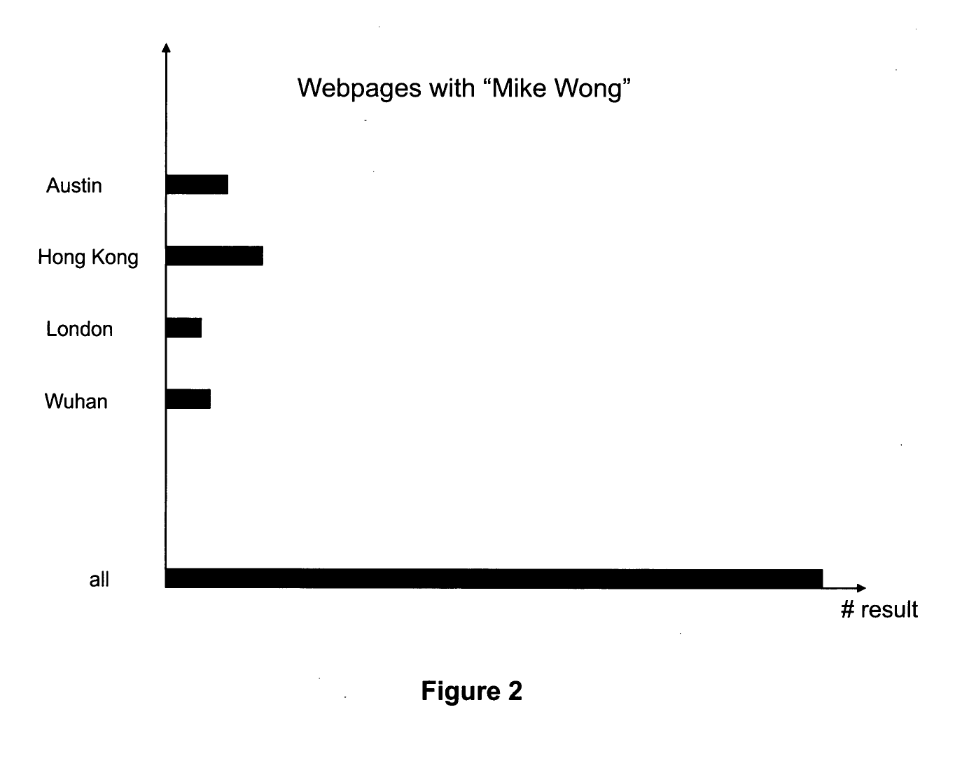

FIG. 2 shows an example graph. At y=0, the bar is the number of results returned by a search engine for all instances of Mike Wong. Conceptually, the graph also shows the number of results for Mike Wong when he is associated with Austin, Hong Kong, London and Wuhan. These results are assumed to be within the full results at y=0. What FIG. 2 does not show is that, if this could be done (to be explained below), then the remaining results at y=0 would be reduced by those amounts “spun off” into those cities, and thus reducing the ambiguity about individual Mike Wongs at y=0.

Granted, when the search engine returns results for Mike Wong, these are sorted in some manner, often using methods proprietary to that search engine. But the key point is that there is no intrinsic way for the search engine to distinguish the different Mike Wongs. Any differences, as in perhaps the order of the results, arises out of the engine's general purpose methods, which maybe or probably have little to do with solid identifications of individuals. Perhaps the search engine does not even have the concept of an individual, inasmuch as it cannot easily or objectively isolate these in the text of pages it spiders. In other words, the search engine might not be able to see any intrinsic difference between a text in a page that says “Mike Wong” and other text in the same page that might say “black sofa”. To the analysis code, these are just different bit sequences.

The GNS offers a possible and voluntary way to remove some ambiguity. Imagine Laura as an acquaintance of a particular Mike Wong. She writes a page that mentions him, in part perhaps as the visible text in a link, “Mike Wong”. The address for this link is a person URL that describes the location of his home (or perhaps office), and his name. The URL goes to gns.com, and we assume that the GNS has this information about Mike. (Note that this is not a link to a page written by Mike himself. Though if such pages exist, Laura can certainly also link to them, in other links.)

Doesn't this intrude on his privacy? Not necessarily. If the location is his office, then the page might be construed as advertising or publicity about Mike's business. He wants such pages written by others about him and his business. He wants to publicise himself and his business. While if the location is his home, then this is not dissimilar to the telephone white pages which give his name and home address. This is quite different from finding and publishing Mike's national id number.

Now imagine such a page that Laura has written. A human reader encountering it can click on the link to find out that this Mike Wong lives (or works) at such-and-such a location. This can help distinguish this person from another of the same name in a different province or city or suburb.

It can also be seen that a search engine now has enough information to programmatically disambiguate all the web pages with links to a “Mike Wong” whenever those links are GNS person URLs. All these pages can then be clustered, where different clusters point to different person URLs. All links with coordinates in a given site refer to the same site and thence presumably to the same Mike Wong. Hence a given cluster corresponds to a given bar in our graph, at y!=0.

In this way, the symmetry or ambiguity is broken for some results, and there is a removal of some of the degeneracy. This can be a great benefit to the search engine in factoring out many results pointing to the same name.

In passing, there is a possible ambiguity: Imagine a site that is a block of flats, and purely coincidentially, two Mike Wongs live in different flats, but the GNS does not have the flat numbers. Even if a web page cannot distinguish between these, though it uses a person URL, this is still a vast improvement, because it excludes all other Mike Wongs living elsewhere. The size of the ambiguity problem is vastly diminished.

It is possible that Laura might mistakenly write a person URL that has Mike Wong, but the wrong address. After the page has been written, published on the Web and spidered by the search engine, this can be programmatically detected by the engine asking the GNS. Hence, one can imagine a search engine doing this and perhaps grouping such a page under a “miscellaneous” or “mistaken” category. The detection of this mistake in Laura's page can also be used by the search engine to lower the credibility of that page, and possibly associated pages at that domain.

Also, consider the process when Laura writes the page. She uses some HTML page writing program that inserts HTML tags automatically. These already exist for standard HTML pages. The novelty is when she gets to writing the person URL for Mike, the program might bring up some window that queries the GNS, and lets her pick a valid URL for her page. Consider by analogy a program that when a user types letters of a word or phrase in a box, the program has a menu popup with suggested words or phrases that fit those starting letters. One example is Google's query box, which in 2009 has this ability. As you type a query, Google shows a menu with the most popular choices made by others, given what you have currently typed.

Likewise, suppose that she has written the page, and not used that aid. So she wrote the person URL manually. Her writing program might still have a button that triggers a check of GNS links, by querying the GNS for the validity of such links. Akin to a spell checker, except that it checks by going across the network to an external database at the GNS.

Also, her writing program could use a history of her earlier pages to improve the efficacy of its suggestions. If in the past she wrote another page and picked a specific Mike Wong at a given address, then the program could cache this person URL and offer it when she writes a new page with a Mike Wong mentioned.

Similarly the program might know where she currently is, or the location that she is usually associated with. The difference between this could be due to the common use of a laptop. If the laptop has GPS ability and can find its current location, this might not always be useful. Especially if Laura moves around a lot. Better might be a fixed address, of her office, say. Or she may have given this location to the program when installing it, by explicitly defining a location.

Then, suppose she had never written about Mike Wong before. The first time she does so, and uses the program to find a person URL from the GNS, the program could pass her location to the GNS as a hint in how the GNS returns possible results. That is, return the Mike Wongs sorted by distance to her. So the first Mike Wong in the list is the closest to her. Or if she has used the GNS before for this type of query, and asked about a different person, then her program can store the location of that person, and use it here as a hint to the GNS about Mike Wong.

Hence we can see numerous types of predictive heuristics that the page writing program and the GNS can use.

One possibility is of a partial identification using the GNS. Laura might, probably with the aid of her writing program, define a location and a radius. Perhaps she does not want to define a specific Mike Wong, or she does not know exactly where he lives. Hence there might be a format for a URL at the GNS for this case. Perhaps “http://gns.com/x= . . . &y= . . . &id=Mike&id2=Wong&radius=20”. Here (x, y) define a center of a circle of radius 20 km, within which is a Mike Wong.

Equivalently, there might be convenience functions offered by the GNS that define URLs at the GNS, where instead of giving an (x, y) and a radius, the postal code or telephone area code or town name is given, along with the person's name. For example, http://gns.com/id=Mike&id2=Wong&country=us&postcode=90011.

So the person is deemed to be within that postal or area code or town. Postal and area codes are unique in a nation, but towns not necessarily. Hence if a town is given, there is some notational means to uniquely specify which town in a country is meant (perhaps by indicating the state or province for that town).

Thus at least for future pages written about people, the GNS can help give more specific indicators about them, and remove some of the degeneracy in new pages. What about pages that do not use the GNS in this way? Even here, it is possible to use the GNS to remove some degeneracy.

Consider a domain, Alpha.com, with various web pages. Several mention a Mike Wong. None use the GNS and person URLs. Now imagine someone who can add a new page to Alpha.com, but not change any existing page. She writes a page and refers to Mike Wong and uses the method of this section to have a person URL.

A search engine could use this as a heuristic to map all the pages in that domain, that mention Mike Wong, to that specific person and person URL defined in the new page. Note that the new page need not even reference (i.e. link to) the existing pages about Mike Wong.

There could be varying levels of confidence in this assignment. If the new page does not reference the existing pages, then this might be a low confidence (tentative) assignment of the existing pages with the new page. While if the new page linked to another page in Alpha.com, that refers to a Mike Wong, then the latter page could be grouped with the new page, with higher confidence. Also, if there are several new pages, that use the same person URL for a given Mike Wong, and they link to existing pages, then the confidence might be increased.

Now consider the search engine dealing with a page with “Mike Wong”, when it gets a query about “Mike Wong”. Suppose the page and others in its domain, Alpha.com, do not have any GNS information about a specific Mike Wong. But the page, or possibly other pages in the domain, has GNS information about a specific “Lucy Leong”, who is mentioned in several pages. The search engine could use the latter as a guide to reducing the ambiguity about Mike Wong. It could move the pages at this domain for Mike Wong into an entry for an “approximate Mike Wong”. The latter would represent several possible Mike Wongs, near the location for the given Lucy Leong. The quantification of “near” could use various means.

One idea is to return the nearest n Mike Wongs, for some value of n. Another is to return all the Mike Wongs within a given radius of Lucy's location. Here n or the radius would be set by other means. Perhaps as search parameters settable by the user entering the query.

Another possibility is if other specific individuals are already defined in Alpha.com using the methods of this section. The search engine might use the locations of these, or possibly some average location and (spread or standard deviation) derived from those, to define a region in which Mike Wong is presumably from. Or, a union of regions around each of the specific individual's locations could be found and all the Mike Wongs in that union would be returned.

The methods in the previous two paragraphs could also involve the search engine checking that at least one Mike Wong exists in those approximate regions. (We assume this is so.)

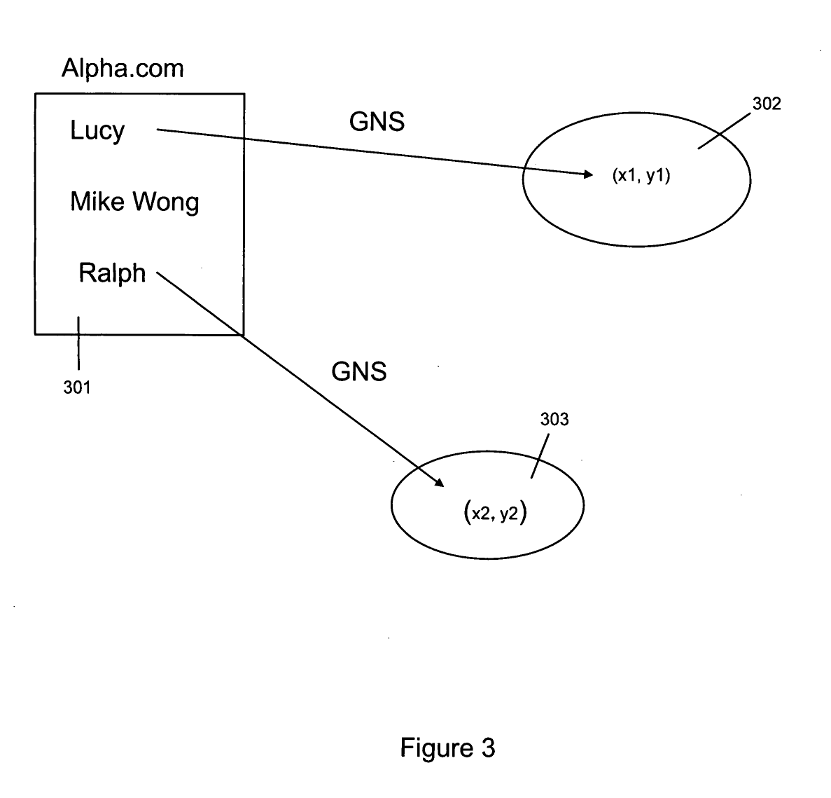

FIG. 3 shows an example. Item 301 represents the web pages of Alpha.com. The pages mention 3 individuals, Mike Wong, Lucy and Ralph. The intent is to find a region or regions associated with Mike Wong, when there are no specific person URLs for him in those pages. But one or more pages has a person URL defined for Lucy, that uses the GNS and points to (x1, y1). Likewise one or more pages has a person URL defined for Ralph, that uses the GNS and points to (x2, y2). The search engine defines a region around (x1, y1), indicated by item 302, and a region around (x2, y2), indicated by item 303. The union of 302 and 303 is the areas associated with Mike Wong, as defined by the search engine.

Hence, the search engine can split its results for all Mike Wongs into clusters of pages, one cluster per each precise individual and those clusters for approximate regions, where in each of the latter regions, there are several possible persons. This would be an improvement over the current situation.

Another approach would use any GNS data that exists for the pages for Mike Wong, where the data refers to locations and not entities like persons or businesses. Or location data might be inferred from textual descriptions like full street addresses. These can also be used to define locations and regions for a given Mike Wong, and applied to split up the original full set of Mike Wong results.

1e. Person File

There could be the equivalent of a CSS refactoring for a domain's pages. So the latter pages might include a common file, a “person file”, which defines a person URL for Mike Wong. Then those “regular” web pages need not explicitly use the person URL. Now all mentions of Mike Wong in the pages are taken to mean the Mike Wong defined in the common file. A CSS file defines common visual markup, while a person file defines common semantic markup for people (and organisations). Note that while we use the term “person” (i.e. singular), the file could have entries for several persons or entities.

This person file need not be restricted to the level of the entire domain. So there could be a hierarchy of person files. Perhaps alpha.com/chess/ might have one person file, defining common person URLs to be used in pages under alpha.com/chess/, while alpha.com/poker/ might have another person file for pages under that address. While the base alpha.com/ defines a default person file. Here, the more specific person files might override the base file when there are conflicts.

A person file might have a field that indicates who wrote it. Possibly the field also gives a person URL for the author, if the author possesses such a URL. More generally, suppose several different people wrote about different persons in the person file. Each person entry could have a field for who wrote that entry.

Also, we said that the regular web pages “might include” the person file. This could be done via an explicit include statement in each page, where we leave the syntax of this as a trivial matter, akin to how CSS files might be included. Or the inclusion might be implicit. So the regular web pages might not have any explicit include statement referring to the person file. Thus current web pages need not be modified. Instead, there might be a convention that in, say, alpha.com/chess/, if a file called, say, “lucy.person” exists, and the contents of that file are in the format of a person file [see following paragraphs for possible examples of format], then all *.html or *.htm files in alpha.com/chess/ are assumed to include this file implicitly.

The format of the person file might be a set of lines of “x=y”, where x refers to a word or phrase in a web page, like “Mike Wong”, and y is a person URL. There could be several lines, of different x values, but the same y value, where other x values might be “Michael Wong”, “Wong, Mike”, “Wong, Michael”. These could be different ways in the pages to write text that refers to the same person. For brevity and robustness, common y values might be factored out in the file, using an alias, so that only in one place in the file is there an actual person URL for the desired person.

Or the person file might use the JavaScript Object Notation (JSON), which is similar to the previous format. (Cf. json.org.)

Alternatively, the person file might be in XML format, where there might be instances of tags like <person> <from> Mike Wong</from> <to> [person URL] </to> </person>. Here, as in the previous paragraph, there might be <person> . . . </person> pairs that all have the same person URL, but have different <from> contents. Clearly, more elaborate tag structures could be devised. The XML format might be preferred over the simple “x=y” lines because the latter has no (obvious) substructure, whereas XML intrinsically allows this.

Possibly, several formats might be allowed for the person file; though only one format for any given instance of a person file. The code that reads the person file might be able to detect and understand all types.

Regardless of format, the above offer ways that, for example, any instance of “Mike Wong” in a web page could be understood via that person file, to map to a specific Mike Wong. Here, the “Mike Wong” is not restricted to when this is the visible text of a clickable link. However, the person file could also let this special case have a different meaning from when the text appears as plain text.

Another nuance is to distinguish between when “Mike Wong” appears when the page is shown in a browser or not. This handles the common and important case when the string is in a comment. Here, the string might be the author of the page, which is an important subcase of comments. Though note that in general, the appearance of the string in a comment does not prove that the string is related to the author. A heuristic could be used that searches for the presence of “author” (case insensitive) and then looks for nearby succeeding characters, terminated by end of line or line feed character, and deems those characters to be the author's name.

If XML is used for the person file, then the structure could be elaborated upon to handle the cases in the previous two paragraphs.

Thus far, we assumed that the person file for, e.g., alpha.com/chess/, would apply to all web pages under that address. If some pages have “Mike Wong” that refers to one specific person and other pages have “Mike Wong” that refer to another, then the person files might have some extra parameters or tags that define the specific persons and to which web pages each definition is applied.

Or perhaps there might then be several person files for that address. One way is that there is a default person file for alpha.com/chess/, that applies to all web pages under that address unless excepted. This default person file defines a default “Mike Wong”. While pages that refer to another Mike Wong will explicitly include a different person file that has the latter person defined.

This can also be extended to when a given web page has two instances of “Mike Wong” and they are deemed to refer to different persons.

The existence and use of such person files could be defined as a de facto industry standard, and search engines could use these to remove some of the degeneracy.

Thus far, the person file has been described as a set of mappings, key→value, where the keys are text strings that might be present in a web page. The key can also be generalised to include the ability to map from an image to a person URL. Suppose we have a web page that has images of people. Each image has a web address. Hence the key could also be such an address of an image file.

In this case, the key can be extended to include a demarcation of part of an image. This handles the case when an image is of several people.

When the key is a text string, then it need not have any address information about the locations of the files containing the key. However, when the key refers to an image, then address information can be included in the key. This need not happen in every instance. There could be conventions where the key does not have a full address of the image file.

Thus far, when considering images, these can be imagined to be static images, in some common encoding format like JPEG or GIF. A generalisation is for moving images, i.e. a file with video, in some common video encoding format. Two issues arise. One is how to pick and follow a given person through the video. The picking might be done manually, while the following is via some algorithm. This is an image recognition problem and is explicitly considered outside the scope of this invention.

The second issue assumes that the first can be done, to some acceptable level of efficacy. It refers to a mapping from a person in the video to GNS data about that person. There might be some notation for the key that gives the address of the video file and optionally “coordinates” or instructions that define a person within the file. This is optional because of the simple case where a video might only have one person, and so a choice is made to associate the entire video with that person. More generally, a video can have several persons, so coordinates or instructions are needed to pick out one specific person.

The mapping can be used by custom software, possibly implemented as browser extensions, or as a standalone application. This software takes the key, loads the video file and uses information in the key to display frames showing the person in question. The software also uses the mapping to access and display the person's information as given by the GNS.

In a standard web browser, if it does not know about person files, then the existence of these will not change the visual appearance of any web pages. However, we can imagine a modified browser that reads the appropriate person file, or sequence of person files, for the web page currently shown in the browser. Then, the browser might markup appropriate instances of text (i.e. names of persons in the person file) in that page. Possibly, this markup could involve one or more of these actions:
a. display the text (e.g. “Mike Wong”) differently from other text.
b. when the mouse is over the text, display the person URL in the base of the browser, much like the URLs in standard links. Though perhaps this display is made visually different from standard links.
c. make the text selectable. If it is selected, show the page addressed by the person URL, or show a popup window with some or all of that page.

This list of actions assumes that “Mike Wong” is visible. When this appears in an HTML comment, the browser might have an option to display the comment, perhaps in a popup or separate window, and highlight the desired text and make it selectable.

Another possibility relates to searching for the string in the URL itself Here there might be rules to transform the string (e.g. “Mike Wong”) to a format satisfying URL syntax rules, and also perhaps conforming to local directory naming rules for that domain. So “Mike Wong” might map to “mike.wong” and the URL is pushed to lower case before searching for whether it contains “mike.wong”. This handles the case where web pages in a directory, e.g. Alpha.com/users/mike.wong/ might not have any mention of “Mike Wong”, but the structure of the URL lets us search it for information.

If a key in the person file refers to an image shown in a web page, then the image might be displayed with some kind of visual marker, like a distinctive border, to distinguish that image from other images not referred to by the person file. Likewise, if the key refers to a subset of an image, then the browser might show that image, and in some manner highlight the subset.

Note a distinction between two types of files. One is a web page with person URLs, and links to existing web pages, that presumably do not have these, or any other, person URLs. Another is the person file, which is included or implicitly referenced by a web page.

The idea of using files with person URLs and linking to existing web pages, that don't have these person URLs, can be taken further. In the previous example, we assumed that new pages were written at a domain with existing pages. But a broader method is for pages at other domains, to define a person URL for Mike Wong, and to link to existing pages in Alpha.com, that mention Mike Wong, but which might not have any person URL. These external pages might be regular web pages. Or the pages might be person files which point to Alpha.com. Below, we describe how the person files can easily do this.

Of course, how reliable are such external links, where here external means from outside Alpha.com? Such links could be unreliable. The author of an external page with such a link could mistakenly have picked a different Mike Wong than that actually meant in the Alpha pages. Or the external author might have done this deliberately. Mischief can be imagined.

What if Alpha has a person URL for Mike Wong, and external pages linking to Alpha have a person URL for a different Mike Wong? Here, the search engine might give greater credence to the Alpha classification. Possibly, it might then turn around and use the imputed misclassification by an external page to help classify that external page, by reducing its credence and thus its ranking, when it appears in some other search results.

Or, if the search engine, based on its own analysis, deems Alpha's person URL to be wrong, and an external page defines a correct person URL, then Alpha's credibility might be reduced. Here perhaps Alpha is under investigation as a suspect website (for some reason), and the investigator might regard Alpha's internal person files as wrong or misleading.

Hence there is now an entire group of new link analysis methods to be devised, that take into account the reliability of links to a page. But this is a natural strength of search engines.

Another possibility arises where a credible domain, say perhaps that of a government, writes such external classification pages. These define specific Mike Wongs in the GNS, and point to external, non-government domains and pages. Thus the government can research and define who it believes a Mike Wong in a non-government page really is. Hence, we can think of this as an overlay on the Web. By “looking through” this overlay, the user gets more information, or at least different information, about existing web pages.

A search engine can then use such credible sources, if these are publicly accessible. But there is nothing to stop the government, or any other organisation, from defining such person files, and using them internally for their own investigations.

Another usage is with aliases. Consider a web page that refers to a “John Doe”. Maybe it describes something about his habits. Perhaps the author of the page deliberately used “John Doe” as a commonly understood anonymous nickname. Jane reads this page, and in another domain writes a web page, linking to the former, with contents indicating that “John Doe” points to a person URL of, e.g. “Tom Yuen”, where the latter is meant to designate an actual person. In other words, the string (“John Doe”) in a target page need not be the same as the name (“Tom Yuen”) in the person URL of the pointing file.

In terms of a structured file, rather than having arbitrary text, a simple way is for the person file in XML format to be easily extended to handle this case. For example, Jane might write a person file in her domain with these contents

<person>
<target> [URL of target page] </target>
<from>John Doe</from>
<to> [person URL for Tom Yuen] </to>
</person>.

Here, we added <target> . . . </target> to point to the page with “John Doe”. Also, in <target>, the URL might have various wildcards, so that a range of pages can be specified. And the file might have several instances of <person>. This person file would not or need not apply to any regular web pages on her domain, but only to external domains given in its target tags.

In a given <person>, there might be several instances of <target>. Each might have a URL of a different domain. This is a compact notation that lets a single <person> map from the same string in several domains, that presumably point to the same person.

A variation of this is where Jane indicates that the alias is not in the text but in the URL name itself. Imagine a social networking domain, social.com, with each user at a URL like social.com/username/. Here Jane might indicate that a given Mike Wong has the username “cherryb” at that website. Thus the <from> might have this value, and there might be an attribute in it, or a separate tag, as a sibling or child of <from>, that indicates the string is present in a directory name.

How to distinguish the two cases, of whether a person file refers to local files or external files (in other domains)? Perhaps through the presence of <target> tags.

It is also possible for local or internal person files to define aliases for local web pages.

Above, we described the <to>as having a specific person URL. One simple generalisation is that it points to everyone at a given site; i.e. all occupants.

A search engine can also offer an extra search option. For a given web page, at some URL, the engine can through spidering find all local person files used by that web page, explicitly or implicitly, where these are in the same domain as that page. Plus, the engine can also return all (external) person files in other domains that point to this page.

Now consider when there are several person files, external and internal, for a given page, as found by the search engine. An analysis option could be made to find agreements and disagreements between these person files. These, especially the disagreements, could be very interesting. If agreements are between person files at different domains, then perhaps these agreements suggest a credible assignment of names within that page to a specific person at a location. This analysis could take into account the credibilities of those domains at which the person files are located. Thus, the search engine could provide a summary or consensus of specific persons in a web page, along with possibly showing the disagreements.

Earlier, we described how a browser could use local person files to alter the display of a web page, by adding links. Likewise, a browser could be changed so that given a web page being shown in it, there could be a means for the browser to let the user type the URL of an external person file. Which is then used by the browser to alter the display of the page, in part by making links defined by that external file.

In the above, the person files could obviously be used where the <from> strings represent organisations or companies at a given location. We chose the phrases “person URL” and “person file” because we suggest that the main usage may be for individuals, but this does not preclude a broader meaning.

On the issue of defining such person files: Suppose these are external to the domains under investigation. One possibility is to have a central web site (“Locator”) with a collection of these person files that point to those domains. The Locator could be separate from the GNS. There might be a web server for the Locator that makes pages that tell visitors which domains are under study, and show the current contents of the person files at the Locator, that point to those domains. The pages let a visitor edit those person files, where possibly this might include comments explaining why the visitor made specific choices of actual persons. This effort could be done across many visitors, akin to how Wikipedia functions. There could be editors that control such volunteer efforts. And visitors might rate the choices made by authors of those files, to give some measure of credibility to those authors.

Suppose this Locator site exists, with person files pointing to various domains. Then a browser could be modified as follows to use this. Suppose the browser is showing some URL. It asks the Locator about this URL. If the Locator has a person file for it, then the Locator returns that file to the browser, which can then use it as described above to alter the page's display. This would be easier than having the user type in the URL of an external person file to be applied to the current page on display.

However, what if a page at some URL has several person files that point to it, where each person file is associated with only one person? The Locator, from its set of all person files, can make another set of files, called perhaps “address files”. Each is for a given URL, and has a list of persons in it. Each person is described by a string, which is presumably present at the URL's page, and by a person URL. (There could be extra data for each person.) We term these address files as a useful label. Even though if a database is used to store the person files, then the address files might simply be another table within that database, as opposed to being actual files in an operating system.

Given the existence of an address file for an URL, the method of two paragraphs previously could be modified to more efficiently have the Locator return the address file for the URL, if it exists.

If there are several such Locator sites, then this is akin to have several certificate authorities. The browser could have an option that lets the user pick a default Locator, to be queried when browsing. Or the browser might let the user pick different Locators as a function of the domain in the URL being shown by the browser. Perhaps a given Locator specialises in some social networking domains, while another Locator is for identifying people in scientific domains, for example.

Another possibility is a Meta-Locator. Similar to a global GNS that refers queries about a location to the appropriate national GNS for that location. The Meta-Locator has a list of Locators and of the domains that the latter specialise in. Hence, if a browser makes the Meta-Locator its default Locator, then when the browser goes to an URL, the Meta-Locator tries to find an appropriate Locator for that domain. None might exist for many or most domains, and several might exist for a given domain. In the latter case, the Meta-Locator can have heuristics to pick amongst the latter Locators, or perhaps return this list to the browser and let it apply any local heuristics or user preferences.

A Locator might let a person referred to by its pages respond. This can be authenticated by various means. One involves the GNS. It can attest that a communication to the Locator purporting to be from a given person at a given location does originate from that person. This communication might be directly from the GNS to the Locator. How the GNS authenticates the message coming from the person to it can be done by various levels of cryptographic means.

The GNS can also report failed authentications. The existence of these can be just as significant as validated ones. They might suggest impersonation attempts.

Note that the authentication is of a message from the person, perhaps stating whether a given person file on the Locator has a correct or incorrect assignment of that person in a third party web page. The message itself is not necessarily correct. The person might wrongly state that an assignment is correct or incorrect. Or this might be deliberately done.

1f. Sorting Search Results for Persons

Suppose a search engine uses the methods described above, and has clusters of pages, where each cluster is associated with a specific Mike Wong. Each of the latter is then a result in response to a search query for “Mike Wong”. How should these persons be sorted? Here, we suppose that the location of the user making the query is irrelevant.

Link analysis could be used in conjunction with the following ideas.

Suppose for simplicity we associate each Mike Wong with his own person file. While Section 1e described the person file and various usages, it did not address in detail how person files were to be filled. One possibility is to induce the person associated with a person file to fill as much of it as possible.

Suppose also that the search engine is using only one person file per person, and that this file is at some reputable website; perhaps one run by the search engine.

One criterion for someone to rise in the person rankings in the search results is that there are numerous entries in his person file. This should not be the sole criterion, as it could induce position spamming, where people write many blogs about themselves, scattered across many domains. Link analysis should be done on the entries in the person file, to obtain some measure of their popularities. For example, the link analysis might be used to derive a single number that represents the popularity of all the links in the file. Then this could be combined in some manner with the number of entries in the file, to obtain a final number that will be used to sort the people. More elaborate steps could be used. Like instead of simply counting up the number of entries in the file, the number might be the number of different domains from those entries.

Separately, consider an application that is used to let someone edit a person file. Suppose Jane is editing this for a Mike Wong and there are already several entries, made by her or others. The application can spider the pages pointed at and extract tokens. It can ask a search engine about “Mike Wong” and also include several tokens. The choosing of which tokens might be by frequency; where of course common words like “the” would be excluded. There could be heuristics that let the application pick out tokens more likely to be distinctive and represent or be associated with some topic. The search engine's results could be filtered by the search engine, to find pages as yet unassigned by any person file. These pages could be presented by the application to Jane, as possibly being about her Mike Wong. This might aid in filling out a person file.

1g. Geographic Maps of Domains

Given the existence of person files describing web pages in a given domain, then other usages arise. These could be implemented as standalone applications, or via browser modifications, or more simply by a web server, that generates standard web pages. The latter specifically includes a search engine offering extra analysis and visualisation options. We now describe some usages. For brevity, we use the term “application”, on the understanding that this covers all cases mentioned in this paragraph.

Consider the domain Alpha.com and associated person files, internal or external. An application can display a map with the distribution of persons mentioned in Alpha. By moving a mouse over a person, the user can bring up a list of web pages in Alpha containing that person, and can pick and see any of these. This list could have a sorting option to show sorted by the number of times a person mentions that person.

Even simpler, the application could take as input an URL. From the associated page, the application shows on the map the locations of all persons mentioned in the page, who are described in the person files associated with the page and the domain.

More simply, the user could use the application to show the page for an URL. The application could highlight in some way the persons in the page that have person files. Then the user can pick a given person, and the application will find the geographically closest other person (as opposed to textually closest), possibly showing both on a map. Or the application could find the furthest other person. The application could have a viewing parameter to let the user pick a choice.

By simple extension, the user could define a region on the map, and thence bring up a list of persons in that region, perhaps sorted by the number of times each person is mentioned in the underlying pages. Each person item might then bring up a submenu of web pages for that person. Or, instead of this two level menu, there might be a menu or list of web pages for that region, omitting mention of persons.

The application could have an option that shows results when only internal person files are used, when only external person files are used, or when both types are used. If disagreements arise, then the different persons that these refer to can be shown on the map in some distinctive manner, different from persons for which there is no disagreement. The application might let the user only see persons with no disagreement, or persons with disagreement.

The application could have an option to make such maps for a given subdomain or set of subdomains of Alpha, or for a given subdirectory or set of subdirectories.

Another option is for the map to only show persons associated with at least a minimum number of web pages, or with at most a maximum number of web pages, where these numbers might be adjustable by the user. That is, show the distribution of “major” persons or “minor” persons.

The application could let the user restrict the use of external person files to those in or not in some domain (different from Alpha) or set of domains (which does not include Alpha). Perhaps the restriction to use external person files in a domain or set of domains is because those domains are considered reliable for this purpose, while not using files in those domains is because the domains are considered unreliable.

The application could have an option to make such maps for a set (“Psi”) of web page domains. Note that Psi is different from a set (“Rho”) of domains with external person files, where Rho was discussed in the previous paragraph. Here the person files could, for each person, contain links to domains in Psi. There might be an overlap between Psi and Rho. Imagine that Psi is {Alpha.com, Beta.com}. Rho might be {Beta.com, Omega.com}, where Beta has a person file that refers to a page in Alpha, and hence the person file is external to Alpha.

The above maps could have a filtering option, where the user enters a list of keywords. Then, only the URLs to pages with exor without some subset of those keywords will be used.

We now can map from a set of web pages to a geographic map. So we can associate an average geographic location with that set. Along with a distance that describes the standard deviation amongst those persons. How might this “average” be defined? One way is simply to place the persons on the map and compute the centroid, giving equal weight to each person. This does not take into account how many pages are associated with each person. Hence, this centroid is the centroid of the “footprint” of the persons. Alternatively, we can weight each person by the number of associated pages, to get a different centroid. Or the weight for a person might be the number of different domains in her list of URLs. Other more complex weightings are possible.

The standard deviation might likewise be found using various weightings.

So for some Alpha.com we have a geographic distribution of persons mentioned by its pages, with the distribution summarised by such metrics or moments like the centroid and standard deviation. Hence Alpha might be summarised geographically by a circle, centred on the centroid and with radius equal to the standard deviation or perhaps half that.

Another set of web pages, say associated with Gamma.com, could also have its geographic distribution and moments.

We can define a geographic distance between two sets of web pages, as the distance between their centroids. The display of both their person distributions on a map might reveal interesting attributes of the people mentioned in the sets.

Trivially then, a map could show the distributions of persons from several sets of pages, {Alpha, Gamma, Kappa, . . . }, and their centroids and deviations. Preferably all such centroids and deviations are computed by the same weighting methods, for better comparisons.

This also means that given a specific set of pages, e.g. Alpha, then out of another set of sets of pages {Gamma, Kappa, . . . }, we can find the set closest to or furthest from Alpha. This is distinct from, and complementary to, using metrics between sets of pages, where these metrics are based on topics of those pages. (Here, we consider persons in those pages to be different from topics of those pages, which in general should be true.)

The above described the use of person files. But web pages can also directly use person URLs. Hence a map could also show these. Perhaps with an option to only show these, only show persons found via person files, and showing both.

Person files could change over time. Including going from non-existent to existent and vice versa, and cycling through these states in that time interval. And web pages can also change over time. Thus the application could show the time varying distribution of persons on the map. Perhaps as an animation.

Also, the application could show the distributions of persons from different sets, and how the distances between the sets of pages vary as functions of time.

A map could show results when the web pages are intersected with other (search) strings. For example, “show the map of people in Alpha.com, where the pages also have ‘bridge’ OR ‘poker’”.

It is possible that web pages have locations mentioned in them. This could be via our location URL and the GNS. Or, more typically, having text in a page that can be programmatically inferred to be an explicit location. Imagine in an American context a street address like “123 Main Street, Anytown Calif. 91003”. In the prior art, some applications like the Yahoo Inc. mail server (cf. mail.yahoo.com) automatically scan an email being shown in the browser for such locations. The Yahoo web page then makes such text clickable, which will bring up a map centred on that street location.

Given a set of web pages, where we can map their persons, then the application can now let the user search for and define subsets of these persons based on geographic proximity; i.e. clusters of users in geographic space. This also lets the user define corresponding subsets of underlying web pages.

For example, imagine Alpha.com having persons broadly distributed in two groups on the map, where the distances between members in a group are less than the distances between members in both groups. The user can then search the associated web pages to see if this geographic clustering correlates with different interests or aspects of those pages. It might be that Alpha's pages span several topics or interests and that this could be discerned in the distribution of persons.

The person file also can allow the following usage. Imagine Alpha's pages, where there are two types of persons mentioned. One type is the authors of the pages, where the authors might be mentioned in the pages. The other type is all other persons in those pages. In some investigations, we might be interested in the distributions of only one type. Maybe we don't care about the authors, but are interested in who they are writing about.

Suppose when the person file is applied to Alpha's pages, for a given page, the author can be programmatically found. Possibly using data in the person file. Then the presence of any person strings, as defined in the person file, in that Alpha page tells us for the given author, the subject persons that author wrote about.

Note that the page might be “written” by that author even if the page is autogenerated by the domain. Imagine a page at a social network domain, social.com, for a user cherryb, with the address social.com/cherryb/. This page may have a complex structure, where this structure is defined by the domain, and not by the individual user, and other persons appear in the page. The latter persons are acquaintances of cherryb, and hence in the context of this invention, cherryb is deemed to have written a page about them.

The application can have an option which lets the user see the distributions of only authors, of only subject persons, or of all persons.

The application can make a directed graph. The nodes are the persons mentioned in the person file. A directed arc like this “Dave→Mandy” means that Dave is an author of a page that mentions Mandy. The graph might have self loops, from Dave to Dave. By generating a directed graph for all of Alpha's pages, the application lets the user understand a summary structure of the pages. Also, in terms of social networks, the directed nature of the graph is useful. It shows who (the authors) are aware of others (the objects).

Also, the generation of the directed graph immediately gives a simple Resource Description Framework (RDF) instance. Where the triples (subject, predicate, object) have the meaning—subject=name of author, predicate=a term indicating authorship, and object=person mentioned by author. Hence, third party analysis tools that take RDF data as input can use the application's output.

For some domains, there might be a flag bidirectional=true. By default this is false and in this case can be omitted. When the flag is true, then if a page, which corresponds to a given author, mentions another person, who is also a user in the domain, then both author and user can be assumed to know of each other. Hence the edge between them on the graph is bidirectional. (Or equivalently, not directed.) This could correspond to where a social domain only permits an author's (structured) page to refer to another user when both have consented to be “friends”.

In this invention, locations could also be shown by the application, marked in some contrasting way from the locations of persons. This lets the user see any possible correlations between the distribution of persons for a set of web pages and the locations in those pages.

From a set of person files, we have a geographic distribution of persons. And we also have an association of each person with a set of tokens and topics. Hence we can derive geographic maps of tokens or topics. For example, the map can show for a given topic where it is most concentrated. It can do this for several topics, to let the user study any overlap.

Marketers can use such a map. If a topic is about something that a marketer wants to sell, then, for example, the regions of low association with the topic could mean there is little interest or usage of the product in those regions. She can then decide whether to focus more sales and advertising effort there. One way could be via search engine ads or banner ads, if these ad placements return the IP address of the browser. By mapping the IP address to an approximate location, if it is in a low usage region, then she places an ad for the product. If the location is in a high usage region, she does not.

Another method relates to where a topic is about products that need servicing or related items. From a map, she finds the high usage regions. She compares these to the distribution of her company's outlets, and those of competitors. If a high usage region coincides with a lack of outlets, then this might suggest opening an outlet there. While if she has an outlet in an area of low usage, then this suggests reducing the inventory there, or even closing the outlet. Or, it could suggest increasing local advertising around the outlet.

It is trivial for her to find her and competitors' outlets. The value added by this invention is in the usage map.

The tokens and topics need not be directly related to the items or services that her company sells. Instead, there might be a correlation between those, either actual or hypothesised.

Also, if we have temporal data about various pages, there could be an animated map showing the distributed popularity of a given topic over time.

Also, we discussed maps of a topic or its tokens. More simply, we can find a map of a given domain, by seeing how the domain is distributed across persons at known locations. If the domain is considered equivalent to a topic, then we have the earlier discussion. But if the domain possibly spans several topics, then for the domain owner to know how the domain is geographically popular can also be useful. The domain might want to do “real world” marketing, or perhaps co-marketing. Then looking at how its popularity is distributed can aid in find regions in which to market.

Above, we described web pages as the underlying data. This is not a necessity. Imagine a set of documents, in various non-HTML formats. In it are mentioned people. Posit Jane writing a person file mapping various strings of names of people to person URLs at the GNS. There could be a notation that lets her designate which particular documents, or subsets of those, a given string applies to. She can run the application against a set of person files, and obtain the above mappings and display options.

For specific types of data, there might be parsing rules to restrict analysis to only subsets of that data. The most important case is email. Parsing to look for names might be confined to the bodies of the emails, skipping the headers. Here it is assumed that whatever format the email is stored in, this format is explicit and hence a programmer can code the parsing to find the header and body of the emails.

Another case is where we have a directory on a computer disk. The parsing rules for this might include whether to restrict parsing to only text files. (With implicit subsidiary rules that define what a text file is.)

Another case is a SQL database. The parsing rules might include most (or all) of the possible SQL queries.

The RDF can also be used to describe when a person, Laura, writes an entry in a person file for a given Mike Wong. This gives a different type of triple, (Laura, X, specific Mike Wong), where X is a predicate for authorship of a person file entry, as distinct from when Mike is the author of a regular page about someone else. This triple might be considered a metadata triple, compared to the earlier triple, if we regard the person file as a metadata markup (=overlay) of the Web. The point here is that we have a directed relationship between Laura and Mike, which in itself can be used to improve our understanding of a given Mike.

Note that the GNS database can be expressed in RDF form, where the subject can be taken as a location and the object being an entity at that location. The predicate could have meanings like “owns” or “rents”, or it could mean “person” or “business”.

1h. Personal History File

Elsewhere in this invention, the history of a location is discussed, where this refers to the owners and tenants for the location. An important different view is of the history of a person (or organisation), where this person is assumed to have moved over time. It is useful to define a Personal History file for an entity, which we take to be a person, with no loss of generality. In XML pseudocode, the file can be considered to have a <defaultName/> and one or more of these

| | |
|---|---|
| <event> | |
| <name /> | <!-- only if her name changed --> |
| <times /> | <!-- start and end times --> |
| <location /> | <!-- where she lived between those times --> |

<!-- other data goes here -->
</event>

Here each tag will have subtags with more structure. The defaultName is one label for the person that can be associated with her over her entire lifetime. The <name> is typically only used if she changed her name. The <location> might use some geocode or address. This might have only an approximate location if there is insufficient knowledge of her whereabouts during that time.

Each <event> might be created whenever she moved to a different location. There might be events with overlapping times, if a person was associated with several locations simultaneously.

For the ancillary data, this might also have times within the start and end times of the enclosing event. To record when some of the data changed while she was at that location; perhaps her domains or email addresses changed, for example.

Given the data that the GNS amasses, making a Personal History file for an individual is possible. Hence, just as the GNS makes a default web page (or data feed) for a location and for a person currently at a location, it can also make a default web page for a person's life.

One usage is for people who lived prior to the Internet or Web. Imagine for example a famous person, like Isaac Newton. A historian could write such a Personal History file, with the aid of the GNS. It emphasises where Newton moved over his lifetime. The ancillary data could point to external sources like biographies of him during certain times. The file does not attempt to replace the need for standard biographies. It complements these by providing a structured, location-emphasised framework. The latter can be considered a new coordinate system against which biographies can be projected.

For people currently alive, or who have overlapped in their lifetimes with the Web, the Personal History file can be useful. It can be used with a search engine's cache of expired files and possibly expired domains. Earlier, when we discussed the person URLs and person files, these were mainly for use against the current Web. But as people move around, and their interests change, then the Personal History file can be more germane. Like some usages of the person file, the Personal History file can be used against searching the web for results that have existed (and no longer exist). It can help disambiguate the results.

The Personal History file can also be used against results that still exist. In general, current results have appeared on the Web over a range of times. Some of these pages may refer to a person (“Mike Wong”) where he was living at an different, earlier location. Hence the use of person files with only current information can be limiting, and possibly lead to wrong results. By adding the use of a Personal History file, disambiguation might be easier.

The search engine regularly spiders the Web. It has a record of when it first encountered a given page at some URL. The engine might also, via some kind of fingerprint of that page (e.g. using hashes), compare that to existing pages. The first appearance of a page at a new URL might actually be the duplication of that page from an earlier different URL. The engine can use this to trace back the origins (in time and in URL address) of a page. This can help it when applying the Personal History against a given page, by using the original earliest time associated with the contents of the page, and not the (later) time when the engine first met the page's URL.

2. Government Implementation

Consider now at the national level how a GNS might be deployed. The implementation would fall naturally to a national government, given the nature of the land registry. A country might be organised into geopolitical subdivisions, called states or provinces or territories. We will use “state” as the name of the subdivision. If accordingly the land registry is devolved to those states, then the national GNS might be implemented by a GNS for each state. In turn, if a state is split into, say, counties, and land registries are maintained at the county level, then the state GNS could refer to an appropriate county GNS. In Step A, such decisions about referral to a subsidiary GNS could be made.

A given GNS does not necessarily have to be entirely run by a government. The government might outsource some or all of the GNS to a private organisation. There might be various levels of outsourcing. That organisation needs access to a land registry. If it already maintains the registry, then it can do all the steps of a GNS described here. But suppose the government maintains control of the (traditional) land registry and it only wants to outsource the extensions described in this invention. Step A could be done by the government, along with the portion of Step B that finds the owner of a land site. While the part of Step B that gives the tenants, and the entirety of Step C would be done by the organisation.

In the previous paragraph, the government need not be a national government. A national government might have its GNS refer or delegate to states' GNS. One state might implement its GNS itself. Another state might outsource its GNS.

Consider now a level of government that does not have sublevels that maintain or outsource their GNS. This government might outsource only part of its GNS. This could be done, unsurprisingly perhaps, on the basis of geography. That is, the government could entirely handle a GNS for its rural regions, and outsource a GNS for its urban regions.

Also, if a government outsources, it might do so to several private organisations. One organisation might maintain a GNS for one city, etc. The separation of duties of different GNSs could be done by geography and may be the simplest way to have any separation.

Suppose there are several organisations each maintaining a GNS. It is possibly unwise to have a given location and its associated URLs be held by several GNSs. The danger is confusion by end users, if an array of GNSs is available. This is analogous to the situation with certificate authorities for SSL-type certificates. A contemporary browser lets a user see a list of these authorities, but it can be unclear to what extent average users even understand this information. More to the point, multiple, geographically overlapping GNSs lead to the possibility of an attack vector of a fake GNS.

This invention also lets a government derive extra revenue. Perhaps by charging fees to those whose network addresses will be returned by the GNS. Or, if it outsources the GNS, in license fees paid by the organisations running the GNS.

3. Alternatives

One question that can be asked is, are there simpler alternatives to GNS? For example, when Jane is at some location, maybe that location could have a wireless transmitter emplaced, that her cellphone can directly contact, for information. This might be done via Bluetooth, assuming that the cellphone can detect such signals.

This is certainly possible and the use of a GNS is not meant to supplant such cases. But there are several considerations.

First, some locations might not have real transmitters. Instead, squatting can happen, where a fraudster emplaces a transmitter on that land site, and the transmitter emits a signal claiming to be the occupant. Not all businesses can be expected to use a real transmitter. Hence, the fraudster might be able to set up a fake transmitter. Note also that the fraudster need not necessarily have to break into the land site. Depending on the geometry of the site and of any building on it, the transmitter might be put on the outside of a building, where unauthorised access is easier.

Or, if the transmitter has a sufficiently powerful and directional signal, the transmitter might be put on a neighbouring site, perhaps where access is easier than the target site.

Second, suppose a location has a real transmitter. A fraudster might still put a fake transmitter, perhaps with a stronger signal. This might be combined with the fraudster being able to turn off or disable the real transmitter.

Third, what gets put out on a transmitter might be very ad hoc, and vary greatly from one location to another. The GNS has a standard national or even global format.

Fourth, the cost of obtaining a transmitter and maintaining a dedicated onsite computer may be more expensive than having the occupant use the GNS. Large, commercial occupants may well do both, but small operations and individuals might not be able to afford the transmitter.

A GNS can combat fake transmitters. Suppose Step C says that there is no local transmitter for a location, and Jane's cellphone finds a transmitter. Then the cellphone can warn her to disregard any information from the transmitter. More strongly, it might not display any such information.

Now suppose Step C says there is a local transmitter. And Jane's phone detects a local signal. Is it from the actual location's transmitter or a fake transmitter? The real transmitter might be able to take part in the following method.

Jane asks her phone to test the transmitter. The phone tells the GNS the phone's location, and says the phone wants to test the transmitter at that location. The GNS makes 2 copies of a unique code. One copy goes to the phone. The other copy goes via some network that the (real) transmitter and the GNS are assumed to be on, to the transmitter. In general, we might anticipate that at a fixed location, a computer, like the transmitter, would be on a land line connection to a network. Also, as more devices become Internet capable, that network would be the Internet. The transmitter will then broadcast this code, which can be detected by the phone, which compares it to the code sent directly from the GNS.

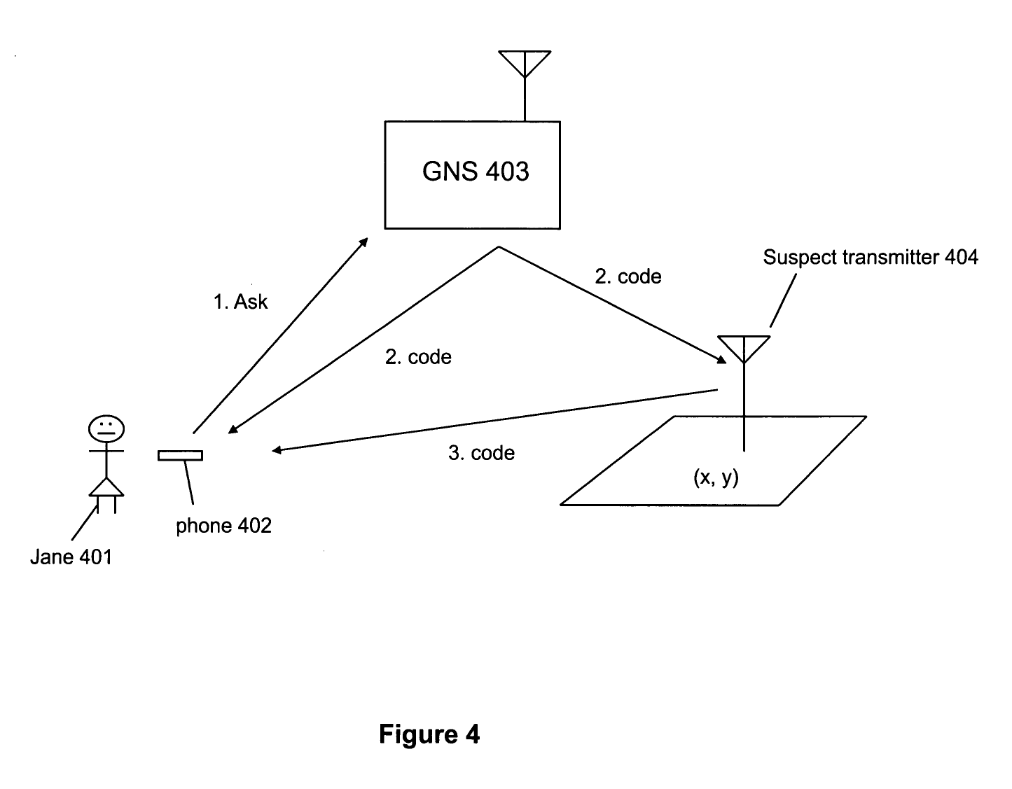

FIG. 4 shows this. Jane 401 has a phone 402. It detects a signal from suspect transmitter 403 at location (x, y). In Step 1, the phone uploads (x, y) to GNS 403 and asks it to send a test code. In Step 2, GNS 403 wirelessly sends the code to the phone, and also via land line to transmitter 403. In Step 3, a real transmitter 403 would then relay this code wirelessly to phone 402, which would then compare it to the code it directly got from the GNS.

This assumes that the transmitter has an ability to get a request from the network and broadcast the code in that request. And that the GNS has the address of the transmitter. Hence the request should be in some published format that the programming in the transmitter can understand.

The other assumption is that a fake transmitter is not using the address of the real transmitter. Essentially, this in turn assumes that a simple “mechanical” attack, where the real transmitter has been disabled, and a fake one used, cannot get at the real transmitter's network connection.

There might also be a need for an account and password at the transmitter. So the signal from the GNS is an interaction between the GNS and the transmitter that is a login session, containing a code. This is technically possible. But the practical aspects of many transmitters having this entry point, and the GNS maintaining passwords for each transmitter might be awkward. (Assuming that the username used by the GNS at each transmitter is the same.) It might not be desirable or practical for the GNS to have login accounts at many transmitters.

A simpler approach would be to regard the GNS request as equivalent to a “ping” in the Internet. This is a low level command to a device on the Internet, which then replies. In this invention, like the ping, no account is needed at the target device. But here, the transmitter (target) gets a request on one network, which we can take to be the Internet, and essentially echoes the request, or at least the code within it, on another (wireless) network, that we take to be Bluetooth in one instantiation. Optionally, the target can send an acknowledgement back to the caller.

In either case, or perhaps especially for the ping case, the transmitter might have logic restricting the maximum number of such broadcasts it will make per unit time, to reduce the possibility of some type of Denial of Service attack. Likewise, the GNS might also have some limit on the number of requests coming from the same or nearby locations, per unit time.

The above assumed that the GNS knows of the real transmitter's fixed address. But it is also possible to envisage where a location has some kind of computer, that routes commands to a transmitter on a subnet. Hence, knowing the fixed address of that computer is sufficient to do the above test.

A simple variant on the above test is where Jane's phone makes a code and sends it to the GNS, which sends it to the transmitter, which then broadcasts it to Jane's phone.

An extra precaution is where both tests are done.

In this section, we used Bluetooth only as one possible type of wireless communication. Since we used no specific property of Bluetooth, the discussion generalises to other types of wireless protocols.

Specifically this includes the important case of a WiFi transmitter. Imagine Jane carrying a cellphone and a laptop, where the latter has WiFi ability. She wants to find a WiFi transmitter in order to connect her laptop to the Internet. She wants to avoid suspect WiFi transmitters. One way is that a person at a location verified by the GNS can emplace a WiFi transmitter, whose Internet address is known to the GNS. Then Jane can use her cellphone as was done above in the Bluetooth case. It contacts the GNS using the cellular network. The GNS generates a code and sends this back to her cellphone and also to the WiFi transmitter. The latter broadcasts this. The assumption is that her phone can display the code, and so too can her laptop. By comparing the displays, she can check that the WiFi transmitter she is using has been registered with the GNS.

Note that the above tests can still be defeated by an attacker who does a Man In The Middle Attack (MITM). But such attacks are very difficult to set up. None of the various fake transmitter methods we described are MITM.

Another reason for the GNS is that an owner or occupant might not be able to put up a transmitter. Perhaps due to inadequate power in a rural region. Or there could be local restrictions on broadcasting. Or a crowded spectrum. Especially if a building has many tenants, and each desires its own transmitter. (And there are other buildings nearby, with their own transmitters.) The use of a GNS lets a person listed for that land site set up a conventional website. The cost of a website is now relatively low, and the skills to design and maintain it are now widely known.

Suppose an owner does put up a transmitter. This might not have adequate coverage, especially if the land site is large. Imagine a large rural park. It could be too expensive to have a transmitter powerful enough for complete coverage. And the geometry of the area might necessitate several transmitters. Whereas for Jane using GPS, it may actually be easier to get an accurate signal than in cities, because of lack of tall buildings that could block some GPS signals from satellites. Here, it is assumed that if Jane were to use GNS, and then contact the Web, it might be through satellites or some other wireless means (e.g. blimps).

The physical inaccessibility can also occur if the site is not on land, but on water. It is possible to imagine a buoy with a requisite transmitter. But the cost of maintaining that, especially in a harsh environment, could be prohibitive.

Another reason for GNS is when Jane is not at the land site she is interested in. Hitherto, we described the case where Jane is physically present at a desired location with a cellphone. But the sole use of a transmitter at that location limits her always to be near there. This does not obviate the case for deliberately limited locality broadcasting. Here GNS acts as a useful supplement, and not as a competing alternative, by reaching out to people not physically present at the desired location.

Hence the GNS lets an occupant of a site deal with two types of visitors. Those physically in proximity and those at remote locations. For the latter, we use “visitor” to mean visit via a remote electronic means, like a web browser.

4. Uniqueness

Suppose as described above in Steps A-C, the GNS returns a single URL. For simplicity, assume that the URL goes to a website, and not a Web Service. Then presumably Jane can now use her cellphone to go to that website. Why use GNS? Why not use a conventional search engine? There are two reasons.

One reason is that a general purpose search engine cannot necessarily be expected to map from a given geographic location to a given website. For one thing, the (x, y) can have a wide range of discrete values, if x and y are measured down to (sub)meter resolution and if the land site is many square meters. Aside from that, it is rare that a given (x, y) that appears in the text of a web page means that the page is actually associated or written by an occupant of that location. Most (x, y) queries to the search engine can be expected to yield no results.

However, if the input location is a full street address, then possibly the search engine might find one or more web pages with that address. But this gives rise to the next reason, which is a serious problem.

The second reason is that in principle, any webpage containing a searched-for address in its text, be it an (x, y) or a street address, and which gets spidered by the search engine, will be returned in the results. This lets someone try to masquerade as the owner or occupant of that land site.

Granted, search engines rank results. But a fraudster can use methods like a link farm to try to boost her pages in the results. (Cf. wikipedia.org/wiki/Link_farm.) Large, heavily trafficked websites are largely immune to this. Their websites often come up first in search results. However websites that might be produced by small, independent stores, for example, typically have few links to them and could be more susceptible to such fraudulent gaming.

The validated uniqueness of a GNS result is the primary value of the GNS. Currently, the associations of a geographic location with a website are done on a completely ad hoc basis. A website might be associated with a location mostly or only because it mentions that location. The GNS does not try, nor can it, in any sense, stifle this informal aspect of the Web. But this association is mostly harmless, so far, mostly because it has no monetary value.

It is possible that a major reason why a mapping between a location and an associated and authorised website has no value is simply because there is currently no means to define such an authorised website. We posit that this is a major utility of the invention.

The value of this can be inferred by looking at various phenomena on the Web. Consider spam. It arose for several reasons. One set of technical reasons is that email, to this day, uses insecure methods. The best known is that a sender field can be forged trivially. Another is that an email server that accepts an incoming email for forwarding has to take most of the header information on trust, since most of the header fields can be altered by a spammer's mail server. (Cf. “Stopping Spam” by A. Schwartz and S. Garfinkel, O'Reilly 1998, ISBN 156592388X.)

In turn, the reason for these weaknesses is that the email protocols were largely settled in the 1980s, before the advent of the Web, when the users of the Internet were not making money off the Internet itself. The Internet mail protocols were thus developed assuming all parties can be trusted. An assumption that failed once the Web developed and had monetary value.

Another phenomenon is phishing, where a phisher typically sets up a pharm website, that looks like a real website; the latter often being a bank. Then the phisher sends emails purporting to be from the bank, with links to the pharm, to induce unwitting users to click on the link and go to the pharm. (Cf. “Phishing and Countermeasures: Understanding the Increasing Problem of Electronic Identity Theft” by M. Jakobsson and S. Myers, Wiley 2006, ISBN 0471782459).

The examples of spam and phishing provide some of the expected utility of a GNS. If a mapping of location to website were ever to have monetary value, then we can expect the analog of pharms to appear, when users search for a location's official website and get another, fraudulent one. The GNS will stifle this.

In this section, we assumed that the result returned by the GNS is just one URL. Obviously, if a set of URLs is returned, where all are valid, then our remarks remain unchanged.

For the URLs that a user provides to the GNS, the GNS might scrutinise these to some degree. For example, the base domain in a URL could be compared to a blacklist of known spammers or malware addresses. If the base domain is in that list, the URL could be rejected. More generally, if the base domain is in some near neighbourhood of an address in the blacklist, then this could also be done.

Possibly if a URL is rejected, other data submitted by the user might then be subject to more scrutiny.

Another possibility also arises, given the nature of the GNS data. Suppose a physical neighbourhood has several users within it that were found to have submitted suspect URLs or other suspect data. Here “suspect” might be defined by analysis external to this invention. Then for another user, in that same physical neighbourhood, extra scrutiny might be applied to its data. This is analogous to how in an IPv4 Class C range, if several addresses are found to be spammers, then the entire range might be blacklisted. The reasoning behind the action for the Class C range is that typically such a range is assigned to the same ISP or Network Service Provider, who then might resell some (all?) numbers to spammers. The underlying suspicion is that the ISP is either a spammer itself, or that for whatever reason it tends to attract spammers.

The reasoning behind using physical proximity is similar. Suppose Deidre and Santosh live in the same area and submitted spammer URLs. The URLs were determined to be spam domains by external means. These URLs might be at quite different Internet address ranges. Deidre and Santosh could have separately established spammer domains at 2 ISPs physically far apart, and with IP addresses also far apart in the IP addressing space. Standard IP range blacklisting would not suffice to correlate Deidre and Santosh. Now suppose Ahmed, who is a neighbour of theirs, submits a URL with an IP address not close to those used by them. The method here of running extra scrutiny based on physical proximity offers a different method of checking. The underlying reasoning is that perhaps all 3 are in collusion as spammers.

There could be various heuristics that define how close physically Ahmed has to be to some concentration of suspected spammers before this triggers extra scrutiny of Ahmed's data.

Also, there could be rules so that if a person keeps submitting URLs found to be spammers or sources of malware, then that person is removed from the GNS for some amount of time. The amount of time could be a function of the severity of spammer or other undesired activity.

Here, removal could mean that the person and her data are not included as results to a GNS query. Though her data could still remain in the GNS database, for internal analysis, and for comparison against data about other users. Also, if a query input of a location maps to a person removed from the database, the result could indicate not null, as this means no data, but a result indicating (suspected) spammer or cracker. This lets end users, as well as downstream analysis tools, see spammer distributions in real space, and possibly make their own decisions regarding a neighbourhood.

In the above, we discussed the case where Deidre and Santosh submitted URLs that were found to be undesired by the GNS. This could apply to other data submitted by an occupant of a location. More generally, it could also apply to information found by the GNS about an occupant, that was not submitted to the GNS by the occupant.

5. Vertical Extension

Thus far, we described a location as (x, y), as two dimensional. It is possible to have a third dimension, z, in the vertical direction, “altitude”. In an urban region, if the location is at a building, then since the building would normally have a street address, the third dimension might simply be considered already implicit in our “full address” that was described earlier. Or this dimension might be explicitly described, e.g. via a floor number.

However, it is also possible to have an explicit altitude coordinate. In an urban region, this could correspond to the air rights that are sometimes present over buildings. (Cf wikipedia.org/wiki/Air_rights.) Some cities have this. In the context of this invention, imagine the owner of air rights above a given building wanting to advertise that it was for rent. If air rights can be owned by a different person than the owner of the underlying building, then it can be seen how the GNS would let a user find the former.

In a rural region, in some countries, mineral rights are separate from farming rights. Hence a z<0 value could be construed as describing or related to the mineral rights.

Over water, the altitude might be a depth. For an (x, y) over deep water, different depths could correspond to different ecosystems. There might be fishing rights granted that are a function of depth. Plus, for the ocean floor, there could be mining rights, entirely separate from any fishing rights. For a river, boating rights might be described by z=0, while fishing rights use z<0.

6. International Territory

Thus far, we assumed that a land or water site is part of a given nation's territory. So a GNS was associated strictly with only one nation. But a GNS can also be used for international territory. There are various international bodies that could be entrusted with owning such a GNS. And just as we described how a national government could derive revenue from running or outsourcing a GNS, so too could an international body.

For a region that is outside a nation's territory, but within its exclusive economic zone, then the nation's GNS could extend its scope to covering such regions. This typically would be for the continental shelf off a nation's coastline.

A GNS could also be used for other bodies in the solar system, especially those whose topography is reasonably well known, like the Moon and Mars.

7. Non Commercial Uses

Most of the monetary value of a GNS will derive from it facilitating commercial transactions. It is precisely because these transactions have monetary value that gives the GNS its value, by validating true parties. However, once a GNS is in place, it could also be used for non-commercial contexts.

One use might be cultural. A nation with an archeological site might permit the organisation supervising that site to put up the authoritative website about it. While any other website cannot be prevented from discussing that physical site, the authoritative site could be easily verified as such. Even if this has no monetary value, we suggest that some nations would see value in being able to define their heritage in this manner.

A similar use might be scientific. An ecosystem in a country might have an authorised website associated with it, for example.

8. Custom Tags

Currently, there are various custom markup tags that are used in web pages to designate latitude and longitude. For a region, there might be existing tags that define the boundaries as a geofence polygon. One such example is “Geo-Extensions-Waypoints” (microformats.org/wiki/geo-waypoints-examples). A custom attribute might be added, e.g. ‘gns=“true’”, that indicates that a certain webpage at a given URL is the one returned by the GNS when queried for a location inside that region.

Or, equivalently, entirely new custom tags might be used that define a region and indicate that the page at that URL is validated by the GNS. A new custom tag might be called

<gns>
<!-- polygon region defined here -->
</gns>

Strictly by way of example, we chose to name the above tag “gns”. As far as we can tell, there are no major usages of a custom tag with that name.

Both approaches are equivalent. An implementation of this invention might use one exor both approaches.

Note that the custom tags, or existing tags with our custom attribute, need not necessarily be in the same file as the webpage. Akin to how CSS refactors style information out of HTML files, an HTML file might include a special file with tags that define the underlying physical region.

There is a benefit to search engines. Suppose a page has a custom tag or attribute that claims to associate the page with a region. The engine can then query the GNS to check if the page's address matches the region defined in the page. Pages that fail this test might be lowered in the listing of results for some or any types of queries. Here, the supposition could be that failing of the test is inherently suspicious for those pages or even for other pages at that website. This measure also acts against someone copying a page associated with a region and a URL to another URL.

A stronger measure with failed pages is to not list them in search results for points in that region. Or even in any search results.

9. Data Collection and Validation

The amassing of data for the GNS can be compared to both how DNS gets its data and how a search engine gathers and analyses data.

The GNS does not have to spider any network. Its data is submitted to it from customers who have their URLs to be associated with regions owned or occupied by the customers. In this sense, there is a large cost saving compared to a search engine that has to spider to gather its data. This aspect is also similar to DNS.

For presenting results, for each query there is at most only I set of results. This set corresponds to the region that the query is in. The set is analogous to a search engine returning only one result (webpage). A set of GNS results is analogous to one webpage. This is similar to DNS returning only one set of results. It is a great simplification compared to a search engine. Much of the complexity and cost of the latter is devoted to sorting myriad results for one query, into an order likely to be meaningful to the user. For GNS, there is either no result exor one set of results.

The issue of validating the data submitted to it by an owner or occupant of a region is central to the running of a GNS. Different GNSs might choose a variety of methods. For example, a GNS can be assumed to have already compiled a mapping from a land plot to its owner. And to regularly get updates from the government land registry when this changes. When an owner wants to input a new URL entry, she might be required to go to a GNS office, or perhaps a suitable government office, with various types of identifications (driver's license, passport etc). She can then tell the office her new URL entry. Also, it can be expected that at some time in the future, she will alter this. So at the office she might be issued with a public/private key pair and associated software to use this. Later, she can send in updated data electronically, possibly signed with PKI.

A stricter approach would be to eschew PKI and require her to show up in person at the office every time she wants to change her data.

Another issue is how much data a user can submit to the GNS. An expected common case is where the user only has several URLs. For simplicity, a GNS might require that the user submit only one URL. This can point to a webpage where she then writes out all her actual desired URLs.

But suppose she has addresses (URLs) that point to intrinsically different types of data. Some addresses are of Web Services or data feeds. If these can be represented on a single webpage, and programmatically accessible via that page, then the GNS could require, as before, that she simply give it one URL and that page will have the data. Alternatively, the GNS might accept multiple addresses from her, and return all these in response to suitable queries.

Another issue is whether tenants or occupants of a property can submit their addresses to the GNS. One approach is that only the owner can do this. Another possibility is that the owner offers only some tenants this ability. Possibly when these tenants pay extra to the owner. Or, all tenants might be able to submit to the GNS.

In the case where tenants can do so, the GNS may require that the owner tell it who those tenants are, so that they can submit directly to the GNS. Alternatively, submissions might be done through the owner, who might also exercise some censorship or approval rights on the contents of those submissions.

The main point is that a posting to the GNS can be tied to a physical location and an entity (person or corporation) at that location. It will not prevent every type of fraud, but will mitigate against the equivalent of technically simple phenomena like spam and phishing.

If fraud is found, the GNS can revoke results for an occupant at a location. If there are several occupants at that location for which this has happened, the GNS might take stronger steps, like revoking all results for all occupants there, and for the owner. This is akin to a Network Service Provider revoking a downstream ISP that has hosted too many rogue domains (i.e. domains affiliated with fraud or malware).

When a person or organisation submits data about their location, this data can include category information. If the person is offering a good or service, there might be a code that describes what type of good or service this is. For example, the code might distinguish between a supermarket and a dental clinic. Related to this, there might be keywords accompanying the code.

The verified association of an entity with a physical location can improve electronic commerce or other non-monetary activities on an electronic network. Other approaches have seen the merit in this, including the use of Extended Validation Certificates. A criterion for a vendor to get such a certificate is that the issuing authority does a verification of the vendor's physical location. (Cf. cybertrust.com, verisign.com.) This differs from earlier certificates that just verified a domain.

In a related context, there are activities on the Internet like people offering or reviewing goods and services in an electronic marketplace. Typically, the vendor or reviewer adopts some username. But for increased credibility, that marketplace might assign a “higher” status if the person has some identification that can be verified by the marketplace. One such example is Amazon Inc, which might designate a book reviewer as having a “Real Name” if that person has submitted credit card information to Amazon that was verified. Thus if an entity has a verifiable physical presence via GNS, this can be used by various websites to enhance credibilities of interactions.

Suppose we have a website offering reviews of location based businesses, like restaurants. The credibility of a reviewer might be enhanced not only if she has a verified location, but also if that location is close to the business. Hence a web view might have different grades of reviewers, or perhaps use location data on reviewers for a multidimensional reputational assessment of them.

10. User Interface

Consider again our putative user Jane, with her cellphone. She is at some location (x, y). The user interface for her to use the GNS can be designed so that she essentially should only have to make a few clicks (maybe even only 1), in order to see the list of validated URLs (and other data) for her location. In the simplest usage, there is nothing for her to type, she just clicks. Easier and reduces a source of errors.

A related idea lets her point her cellphone in some direction. Assume that the cellphone has some internal means of finding that orientation. This now defines a vector, from her cellphone location, in that direction. This can be queried to a GNS, which will extend that vector and then return results for the first region with results that the vector intersects.

This is simpler than assuming that the phone has some ability akin to a laser range finder or sonar, say, that emits a signal and gets a reflected signal in order to find a location that she is interested in. We include this scenario, but it does entail more complexity in the cellphone hardware.

The results returned by the GNS could also include phone numbers. If Jane is viewing the results in a web browser on her cellphone, any phone numbers might be tagged in a format so that by her picking one of these numbers, then her phone will automatically dial it. Effectively, this makes a phone number as “clickable” as a conventional hyperlink in a webpage.

Similarly, suppose Jane uses a non-cellphone computer to view the results. The browser might have an implementation so that if she picks one of the tagged phone numbers, the browser will go to a VoIP website, so that she can ring that number through the browser.

If Jane uses a cellphone, it is in general suboptimal to have her phone's web browser try to use VoIP, when the phone itself can be assumed to be optimised for voice calls.

Suppose Jane uses a computer to search the Web. The computer could be fixed or mobile. The search engine she uses might have a search option where she inputs a location. The results can give special and prominent placement to the validated URLs given by a GNS. This assumes that the search engine has some programmatic interface to a GNS, or possibly even runs a GNS.

Now imagine that instead of a cellphone, she is wearing enhanced spectacles that modify her vision by annotating her view with tags by third parties on the Web (augmented reality). This can be considered a folksonomy (i.e. collective tagging). The user interface could preferentially show tags from the validated URLs associated with the location she is looking at. While folksonomy has some appeal, the very fact that anyone could contribute tags means that any single contribution likely has little a priori value or reliability. In folksonomy reliability is meant to arise out of a group effort in tagging, to overcome the weakness that any single contribution is not usually verified.

With a GNS, the user can toggle between seeing tags written by a folksonomy and those by verified owners or occupants. This does not guarantee that the tags are accurate, but at least that the authors are verified.

Now consider third party Web domains. Imagine an equivalent of Google Earth, where the user has a browser and types an address and sees a photo of a building at that address. Data from the GNS for that address can be used to embed links in that webpage. These let the user contact occupants of that building, or go to web sites they advertise or advocate.

Imagine a real estate listing website, where the user types an address and then sees an image of a building at that address and its price history, along with an estimate of its current value. As in the previous paragraph, links can be put in the image that point to the current owner or occupant. By a user being able to directly contact those entities, she can find out more information about the building. This could facilitate a transaction. Plus, the direct contact may help drive down brokerage fees, by reducing the need for an intermediary.

Here the role of the GNS in providing accurate contact information is vital, to reduce the possibility of fraud.

The historical data provided by the GNS can also be useful. Contact information (to the extent that this exists) about previous occupants or owners can let the user reach them. Perhaps for more information about the history of the location and the circumstances of why they left. For a user interested in being a buyer or tenant, it can be important to learn why other entities have left the location. Perhaps a commercial location had a high turnover of businesses due to a lack of vehicle traffic. Or because the location was hard to see from the street. Practical considerations that can cause a business to fail.

Note that even the simpler data about the number of tenants over a given time, or the lack thereof, can be useful. If a commercial location has had numerous tenants, then this might raise questions about the usefulness of the location. Also, the user can investigate nearby locations, to try to discern if there is a problem unique to a specific location or more generally to the neighbourhood.

In general, an owner of a building for lease might be reluctant or unable to furnish contact information for earlier tenants. There is an asymmetry in the relationship between the owner and a potential tenant, in the amount of knowledge each has about the location. Here, the GNS can help potential tenants make better informed decisions by giving them more access to knowledge.

11. Advertising Rights and Licensing

A major incentive for the implementation of this invention is the possibility of creating new advertising channels. On the Web, a domain name can have great value, especially if it is easy to remember and has some semantic value. Using a GNS, a validated address associated with a widely visited (popular) physical location might have similar value.

Here the visiting of the location can be both physical onsite visiting and remote visiting via a browser.

If the GNS result for a location is easy to see and select on a browser or cellphone display, as has been described earlier, then this increases the chance of a GNS result having value.

Consider now a reality markup situation, where physical visitors to a location wear glasses that show markup tags overlaid on their vision. We described earlier how these tags could be GNS results. The tag contents could include advertising links. Presumably for greater efficacy, the links could have some semantic affiliation with the physical objects they are overlaid on.

The GNS results can be considered electronic air rights, akin to conventional air rights. One difference is that the latter is typically held or owned by the owner of the property. If the property has tenants, they do not have any air rights. With GNS, as discussed in Section 9, tenants can have (electronic) air rights, as there is no intrinsic physical constraint to prevent this.

The owner of a property may choose to auction off its GNS rights.

It should be noted that if advertising happens with GNS, it has more incentive to be relevant or interesting to a viewer than conventional advertising. For the latter, imagine a billboard at a popular location. The billboard's attraction is that a visitor cannot block it out from her view. With GNS results, these appear inside a browser (or something equivalent), or in enhanced vision, via possibly spectacles. For these, a physical visitor may be able to choose not to display a webpage of ads in a browser or advertising markups in her vision.

Hence, in terms of relevant advertising, the most obvious use is when the location is a store, and the advertising is about the store products. The point is that when someone visits a store, it is often to make a purchase, so GNS results geared to this particular store are relevant.

12. Mobile Locations

Some special businesses and individuals might reside in mobile locations. Perhaps a cargo or passenger ship. If the vehicle moves along regular and predictable routes, then a generalisation of Step A could be the programmatic definition of such a route.

A GNS could still validate a vehicle. Assume that the vehicle has some wireless means of communicating with the GNS. At some initial time, when the vehicle is stationary, the GNS validates the vehicle. This might be done by various means, including physical onsite inspection. Then, knowing that the vehicle will later be moving, the GNS and the vehicle might share a known secret, like a common key to a symmetric cryptosystem. Or both might decide to later interact via PKI.

Later, when the vehicle is moving, the GNS and the vehicle periodically communicate. This could be done using the previously agreed upon cryptosystem or PKI. And the GNS can update its table with the location of the vehicle.

Alternatively, the GNS might record only an approximate location of the vehicle. Especially if it cannot contact the vehicle during movement.

13. Identity and Image Validation

Once a GNS exists, it can offer a simple service. The occupants of locations might fall into two types. One is businesses and the other is individuals. Generally, a business might have no problem with the GNS publishing certain information about it. This constitutes validated information that the business would want potential customers to know. The analogy is the telephone yellow pages.

However an individual at a location would not necessarily want much information to be divulged, for privacy and safety.

In Section 1, we discussed briefly how a GNS could provide authenticated information about a person, tied to a location. An application concerns social websites, e.g. for dating. Here, the somewhat anonymous nature of postings can be part of the appeal. But it can also be a source of danger. A website may be able to verify that a person has an address, and then display the result of this verification, without publishing the address itself, when the person makes a posting.

More generally, consider when two strangers are to meet in person for the first time. Previously, they have communicated electronically, via email, Instant Messaging, etc. For safety's sake, one person, Jane, might want some kind of validation about the other, Ralph, and prior to the meeting. Ralph might say that he is validated by the GNS. Perhaps for privacy, the GNS might not say publicly if an individual lives at a location, or, if it does, it might not say more than the person's name. Equivalent to the telephone white pages.

However, the GNS can offer the following service. Ralph logs into the GNS. He asks it to provide a webpage showing his photo and some other data, like his full name, address and date of birth. In general, this is some subset of the data the GNS already has on him. The GNS makes this page, and gives it an address (URL), like
http://gns.com/doc/a01ded015189fb

The argument after the “clod” might be a hash, or something equivalent. This page, at that address, will be made available on the GNS web server for some period of time.

One variant is that the GNS has a predetermined set of fields that go into the page. Or, if Ralph can indeed specify what fields are in the page, that some fields are always mandatory, like his photo and name.

The GNS emails the link to Ralph, who then forwards it to Jane. Or preferably the GNS emails it directly to Jane (Ralph has given the GNS Jane's email address.) She can then see a photo of Ralph and read his ancillary data. Thru standard operations on her browser, she can save the webpage, print it, and forward a copy, perhaps to a friend for safekeeping.

Note that the GNS should not email Jane and enclose the data and image/s entirely in the email. Since email routing is insecure, it allows for an attack. Having the email contain a link to the GNS server is safer.

An alternate, equivalent formulation is for the GNS to generate a unique string, upon request by Ralph. It then emails Ralph or Jane with it. Jane then goes to the GNS website and submits the string in a suitable input box to view Ralph's information. This is more cumbersome than the link approach above, however.

Jane can, and probably should, still meet Ralph in a public place. With a printout of the page. Or, if she has a cellphone with Web capability, she brings up that GNS page. The comparing of his photo on the webpage with his physical image is a simple and perhaps strong test of his identity. She has gotten the webpage from a reputable source. This minimises the possibility that Ralph has a false physical photo id. Few laymen can tell the veracity of standard photo ids.

This also gets around an awkward point about social encounters, where etiquette might inhibit Jane from directly asking Ralph for id. Such encounters are intrinsically different from encounters like a security guard at a building entrance wanting to see photo id.

A hardware device is possible. An augmented reality spectacles, as also discussed in Section 10. There are several possibilities. First, suppose Jane has gotten email from Ralph with a link to the GNS web page with a photo of him. When she meets him and she is wearing the spectacles, it can display to her the image from the GNS page, so that she can compare it to his in person image. Also her spectacles, perhaps in conjunction with other hardware she has, might do a facial recognition comparison between the image in the GNS page and his in person image. If the comparison is deemed not enough, the spectacles might take an image of him and archive it for her safety. Or, if she does a manual comparison and thinks there is no match, she might instruct her spectacles to take an image and archive it.

A second usage is if Ralph broadcasts wirelessly his GNS address. Here, he might not have been in earlier communication with Jane. His device might be a cellphone or some other device capable of doing local wireless broadcasting, and possibly of accessing the Internet wirelessly. Her spectacles could have the ability to detect Ralph's broadcast and in turn wirelessly contact the GNS and download the page, possibly for the image comparison discussed in the previous paragraph. The wireless protocol between Ralph's device and Jane's spectacles might be different from that between the spectacles and the GNS.

Why does Ralph broadcast his GNS address? One possibility is that Jane's spectacles wirelessly asks Ralph's device for this. Another possibility, not exclusive to the first, is that there is some possibly social or commercial situation where Ralph voluntarily does so, mostly or in part to let others like Jane see that he has a verifiable address and image at the GNS.

One commercial context could be a marketplace. Ralph might be a vendor, and he broadcasts his GNS address as a form of identity. This could be useful in casual marketplaces (e.g. flea markets), or where the vendors are “informal” (e.g. scalpers of tickets for events).

Above, we have a method where the webpage has a public address. More elaborate methods can be imagined, for example where Jane might be required to have some type of account at the GNS (though she does not necessarily need to have any validated information). And where thus Jane is emailed a secure address of a webpage (e.g. that uses https), that needs her to login to see the page.

Notice here that Jane need not necessarily want to know Ralph's address. (Though in general the location is extra information that can reassure her.) But by Ralph being in the GNS database, this ancillary use emerges.

The GNS might charge Ralph for making this custom webpage. It might offer the choice of the public page or the private page, and charge extra for the latter.

This idea of the GNS validating a person's identity can be carried much further. The user might voluntarily furnish biometric data, like fingerprints, retinal prints, palm prints, toe prints, voice prints or DNA. Some countries might require some subset of this information.

Note that if the GNS does hold such data, and does so for many people in a nation, that this strongly suggests that the GNS be run directly by a national government.

The information can then be used to verify the person's identity. One extreme usage might be that the person carries no id. But through some subset of stored data types, like her fingerprints, her identity can be verified by the GNS.

Another usage might be as a backup to conventional physical ids. Suppose Jane loses her passport when travelling. As an ad hoc or informal process for verifying her identity, she could direct queries to the GNS.

This logic can be carried further. One projection for the future is that of a global ubiquitous Internet. Under such circumstances, if the GNS can be reached wherever there is an Internet connection, and if it has biometrics or other descriptive data for an individual, then perhaps the GNS can substitute for a physical id carried by a person.

The closest analogy to this currently is when a person loses a credit card. She can ring her credit card company. On the phone, without any visuals, she answers several questions to establish her identity to the company. Extrapolating from this by adding visual and other biometric information, then a role for the GNS emerges.

If however a GNS would act in this fashion, issues of concern might arise. We earlier suggested how different countries would run their own GNS. But a nation might be concerned that its GNS did not reveal too much about its citizens, especially their biometrics, to external queries. Consider the example of Jane above. Suppose she is an American citizen travelling in India and loses her passport. She goes to a police station and explains this, and asks them to contact the (American) GNS. She tells the police her American address, which the GNS is assumed to have, along with her fingerprints. Suppose the police digitise one of her fingerprints. They query the GNS with her name, address and fingerprint. The GNS will reply yes or no according to whether the proferred data matches their data. Here, the GNS never typically transmits its stored biometrics. It only usually accepts external biometrics in queries and searches for matches. Whereas Jane's name and address might be public, as discussed earlier, by analogy with the telephone white pages.

From an information theoretic standpoint: Imagine a hostile entity external to a nation querying the nation's GNS with a person's name and address and some fake biometric. When the GNS replies ‘no match’, all this tells the entity is that the proferred biometric is not valid. But the range of possible values of a given type of biometric is so large that this datum does not aid the attacker in constraining the set of actual populated values.

When we said in Step C that various electronic addresses could be furnished for an occupant of a location, the GNS could deliberately act as an obfuscating intermediary. We described how the occupant could define a username, and then someone emailing to that username at that location would cause the GNS to forward to another email address. This redirection might be used by the occupant to mask her actual email address from general perusal on the GNS. An analogy here is with the popular website craigslist.org. Someone submitting a listing has the option of providing her actual email address or having craigslist make up a temporary one, which forwards to the actual address.

14. Extended Analysis

Once a GNS has data found in Steps A-C, it can easily and programmatically perform analyses on the data for higher order results.

For example, if the data includes a code for what type of business occupant is present at a location, then the GNS can easily amass a table of all instances of a given type in a region. Like all the dental clinics.

If a location has a data feed, this might have fields that give more details about what the location sells or buys. It might also give real time information about how busy the location currently is. The location might be a service station or supermarket. Here, the occupancy of the location's vehicular area (e.g. car park) could be taken as a proxy for usage level. If computations and associated hardware continue to drop in price, then the cost of reporting this becomes negligible.

Currently, a search engine might have to hire people to manually find [e.g.] all the restaurants and other shops in a region. And even then, those places do not typically have real time usage information available. Our method lets the finding of types of locations be simple to automate. While giving those places a way to more widely disseminate real time usages, and hence perhaps make that data more useful.

Consider again the example from 2 paragraphs prior, about the occupancy of a parking area for a shop. Here, the number promulgated might be the number of occupied spaces, or perhaps more usefully to someone who is not already there, the number of free spaces. Each number is essentially the inverse of the other, and thus both incarnate the same idea of real time telling of a quantity. Extending this idea, we can envisage a shop broadcasting some or all of its inventory levels, and associated prices. This could be done via a webpage, with a search option, or by a data feed. If the latter, then the GNS or a third party service that uses the GNS could in turn collate such data across a region and make it available to the end user Jane.

Currently, most stores do not publicly release their inventory figures, real time or otherwise. But increasingly, more stores have more inventory data available internally, and these might be updated regularly. Hence, as electronic coverage improves, there should be no technical obstacle to a store doing the above fine grained approach and promulgating it with the aid of a GNS.

Other types of data feeds could include temperature, humidity, precipitation and wind velocity. Some buildings might have these weather sensors and be willing to publish these as data feeds and also be listed in the GNS. Plus, there could be weather sensors distributed over a rural region.

This lets an end user compile a distributed weather map for any arbitrary region serviced by the GNS and which has locations offering such data.

There are already cases of weather data being electronically collected from several locations. However, these tend to be hardwired, inasmuch as the sensors might be run by one organisation that has physically emplaced these in different locations. Perhaps by a professional weather reporting service. But this is expensive.

Other instances could be where data was solicited on an ad hoc manual basis from several sources, where the locations of the sources was taken on trust. Granted, this was probably a reasonable assumption, because there seems little monetary incentive for the locations to be false. But the point of our example is that the GNS permits a far more extensive network of data collection, with verified locations.

Another example could be the development of a better system of earthquake sensors. The current state of the art in the US is the Advanced National Seismic System, with some 7000 sensors scattered over the US. (Cf. earthquake.usgs.gov/research/monitoring/anss.) While impressive, if sensor costs fall, our invention of a GNS could led to a cheaper and more extensive deployment, in the US and globally.

Another example of a data feed could be video, that possibly has an accompanying audio signal. The owner of the camera might offer this data, where this could be still images, or a live feed, possibly with some time delay specified. The camera might have pan and zoom controls, and these could be set remotely by a user of the data feed.

More generally, a location could have a photon detector that detects in some range/s of the electromagnetic spectrum. Or it could be a particle detector. The sensitivity and orientation of the detector might be controllable by the user of the data feed.

In all these cases of a data feed being offered from a validated location, the owner of the feed could offer it for free. Or perhaps let the feed be used contingent on payment. One elaboration is that if several people want to compete for an exclusive use of the feed at some future time interval, this could be done via an auction, possibly electronic. Here the exclusiveness might or should include an exclusive ability to remotely define the settings or parameters of the feed. The exclusiveness may or may not extend to being the exclusive recipient of the resultant feed. Possibly one user might pay for the exclusive settings of the feed, while she and others pay separately for getting the resultant feed.

One prospect here is for the owner of a camera overlooking a popular location to sell streaming video rights. Imagine for example a camera overlooking Piccadilly Circus in London, or Times Square in New York. Currently, some owners of web cams offer their feeds freely on the Internet, but finding interesting views is rather ad hoc. There may be a paying market for live, high resolution feeds of iconic locations. People pay a lot to be physical tourists, while our invention offers cheap electronic tourism.

Another possibility is for demographic analysis. Imagine cameras in various cities in a nation. Different types of statistical analysis could be done. For example, imagine sampling the fashions of the clothes worn by pedestrians. Or getting estimates of the weight and height distributions. Or surveilling for the visible presence of people having the flu. The spatial distribution of results from different cameras could be useful information in its own right.

For public safety, in some countries or regions, for a camera feed to be found via GNS, a condition might be imposed that a software switch (e.g. special account and password) be made available, so that the government could access the feed, perhaps controlling its parameters (e.g. pan and zoom). Possibly, during this, the feed would be exclusively to the government.

Some validated locations might have the equivalent of “survey stations”. People nearby with cellphones could search and find these via the GNS. The fact that these are validated by the GNS could attest to their reputability. Hence, the stations could offer surveys and other services (e.g. promotional giveaways) and get extra demographic information from visitors that might not otherwise be possible.

In a related way, some validated locations might be in the important category of cash dispensers or Automated Teller Machines. Third party ATMs might be suspect, because it is not clear who owns these. But the validated location of such an ATM by the GNS could aid in its veracity, and hence in the business it transacts.

Another example is for the owner of a telescope to make it remotely controllable and to sell observation time to a global market. Large observatories are now heavily automated, and the data from these are often sent to researchers across the globe. The problem is that those telescopes are in heavy demand, and scheduling time is expensive, and often results in the observer not getting enough observation time. There is currently an unmet need for more telescopes. (Supply limited.) Our invention lets the trend for remote telescope usage be devolved much further. So owners of modest telescopes, that may be strategically located, can derive some revenue.

Thus far, we have considered arbitrary data feeds from locations verified by GNS. Where the data flows one way from those locations to end users elsewhere; though perhaps with various parameters going the other way, to constrain or filter the output. Another possibility is for data to be downloaded to those locations. Imagine a vendor selling a digital product, and who is perhaps worried about piracy (unauthorised usage). It might download only to a network address that can be associated with a physical location, and GNS could be used to do this. Or, it might offer a discount to be able to download to such an address.

Note here that the network address itself is not necessarily physically located at or near that location. The address might be dynamically allocated to the user, via DHCP or equivalent, whenever she connects to her ISP. So the address could be in a range of addresses allocated to the ISP, which will be in a different location.

A variation on the above is where the vendor downloads to that network address not the entire product, but a key that unlocks it. The product itself might be disseminated by other means (e.g. DVD).

Another use of a GNS is with Digital Rights Management. Some DRM methods look for the country or region that the computer is in, since some products are only meant to be used within certain regions. If a person or organisation is using such a product and has a validated GNS location, then the DRM could query the GNS. This assumes that the DRM package sits on a network where it can reach the GNS, and that the DRM has no independent means of accessing GPS. The query to the GNS might involve a signature associated with the user. Analogous to how we described earlier in Section 13 how Ralph can get a link or other equivalent signature from the GNS. There, the link was then manually used by Jane to verify with the GNS. For the DRM, there could be an equivalent computational process.

If the reply is suitable, then the DRM could unlock the product.

A refinement on this is related to Section 15 on inventory listings. Suppose the GNS can verify or has verified that the item (hardware or software) containing the DRM is at a given location. Then later, the DRM asks the GNS with a serial number of the item as the search key. The GNS replies with the item's location, in some format understandable by the DRM. The decision by the DRM to query the GNS could be via some initialisation in a control file read by the DRM when it starts up. The result from the GNS might include the date when the GNS last verified the item's location. So if the date is too far in the past, the DRM will not unlock the item.

Assuming that the date is not too far in the past, the DRM can compare the location result with some internal logic about valid locations, to decide whether to unlock the item.

15. Inventory Listings and Control

Another use of the GNS could be to verify and record an inventory of items at a location. This could require an onsite inspection by the GNS at the location. The data about each item could include some type of serial number uniquely designating that item, as well as a location of the item. The results of the inventory can be published as a webpage or data feed. The webpage or data feed would not be from a source controlled by the person or organisation at that location. Instead, the GNS could itself publish the data.

Possibly, this might require some kind of restricted access. Or perhaps, as in Section 13, the GNS might generate a limited time webpage or data feed.

There are various uses. One is insurance. The occupant of a location might want to insure her items. An insurance company will want some kind of documentation about the items. By the GNS providing it, the company could save the expense of sending out its personnel.

Another use is inventory control. A traditional company could have existing steps and personnel to do this. But imagine a different type of organisational structure, where a company can outsource some of its inventory control to the GNS.

The GNS might also allow specialised searching of the inventory data that it holds itself. A query might have a part number or serial number or vehicle id or RFID value or MAC address.

16. Hardware

There is a need for hardware redundancy and quick response to GNS queries. Also, there is a natural geographical hierarchy that GNS can be implemented in. The combination can lead to the deployment of GNS servers, where each services some region. Each server would have an Internet connection; wired if possible. The server could also be connected to a cellphone or landline phone network, so that those phone networks have easy and quick access.

To determine its own location, it might have a GPS receiver. Though the need for this could be minimal, if it is fixed.

In a given region that a GNS server serves, the simplistic condition for location is at the geographic center. In practice, this will likely be modified by the need for the server to connect to a wide bandwidth Internet pipe. The server should be close to or connected directly to the main Internet backbone in that region.

Another aspect involves caches or mirrors of the data. Some third parties, like Akamai Inc, offer to place caches or mirrors of major websites at various geographic locations. This speeds up the response to users when they query those websites. (Or the website itself might decide to maintain its own caches.) While the query might go to one central location, the latter then forwards it to a cache or mirror closest to the user, so that the data sent in reply travels the shortest distance. It can be expected under normal circumstances the most common GNS queries about locations in a given city will come from that city; especially if these emanate from cellphones. Thus the placing of a GNS server in the city, with data about the city, can by default often give the fastest response. This reduces the need for the GNS to have many caches or mirrors of that data elsewhere. It should still have at least one, for redundancy, as opposed to optimizing responses.

At the user or client level, there can be a specialized mobile hardware device. It has a wireless Internet connection (perhaps using WiMax or WiFi) and a GPS receiver. One default usage is to surf the Internet. It can also take its current location from the GPS and format this into an Internet query to the GNS. Essentially, this is the cellphone described in Section 1, with the cellular ability removed. By doing this, its complexity might be much less than a standard cellphone. The device can have a display and an [optional] keyboard.

Also, there could be customizations specific to GNS usage. One is to be able to display all or some of the GNS locations in some region around the device's location. The definition of this region might be adjustable by the user, who could also be able to define subsets of results. For example by using keywords in a simple search fashion.

A variant of this device could omit the display. Instead, it could feed its results into a Heads Up Display (aka. augmented reality spectacles).

17. Feedback Ratings

Just as participants in online auctions or other online marketplaces might have feedback ratings, so too can entities listed by the GNS. A GNS might let any person anonymously comment on a verified entity (at some location). Also, or alternatively, it might permit reviews by people who can provide some aspect of identity to the GNS. This might be done via the verified possession of a credit card. Or, of course, if the reviewer is already known to the GNS as being verified.

18. Demographic Surveys of Location

Another application could be in demographic analysis that correlates behaviour on the web with the physical locations of the users. Currently, studies of this type might be dependent on self reporting by users of their locations. The GNS improves upon this.

One possibility is this arrangement
GNS <----------- mark@somehow.com <----------- Q

Imagine Q is some company that has Mark and others on its mailing list. Q does not know where its users live. But it would be useful to Q to have some rough indication of the geographic distribution.

It might be asked, why doesn't Q just take its users' email addresses and ask the GNS where they live? To the extent that this is possible, Q should. But it might get no or incomplete information. First, the GNS might have a policy against revealing that. It might hold email addresses as non-public data. Second, it cannot be expected that the user would tell Q his email address that the GNS has on record for him. Many users have multiple addresses, in part for privacy. In this case, especially because some users may regard their email address with the GNS as sensitive, they might rarely give that out to other websites. Hence we describe the methods below.

For those on its mailing list, Q can send an email. In one arrangement, each email has a body with the same text. Then, the recipients who are also known to the GNS can forward these to the GNS. Here, a recipient need not have to forward from the same account that he has given to Q. So above, Mark might email to the GNS from a different account than mark@somehow.com. But Mark would send to the GNS from an email account that the GNS has already associated with him.

Prior to this, Q has contacted the GNS and made arrangements so that the GNS can expect these messages. For the GNS to detect these, out of all types of messages it gets, Q might send the GNS a copy of the message that the users will get. Hence, when the GNS gets such a message, it adds to a table, indicating what neighbourhood the message came from. Here, Q and the GNS have come to some arrangement about how fine resolutioned the neighbourhood will be.

After some elapsed time, the survey can be closed. The distribution of respondents can then be sent from the GNS to Q. So Q never finds the actual locations of its users.

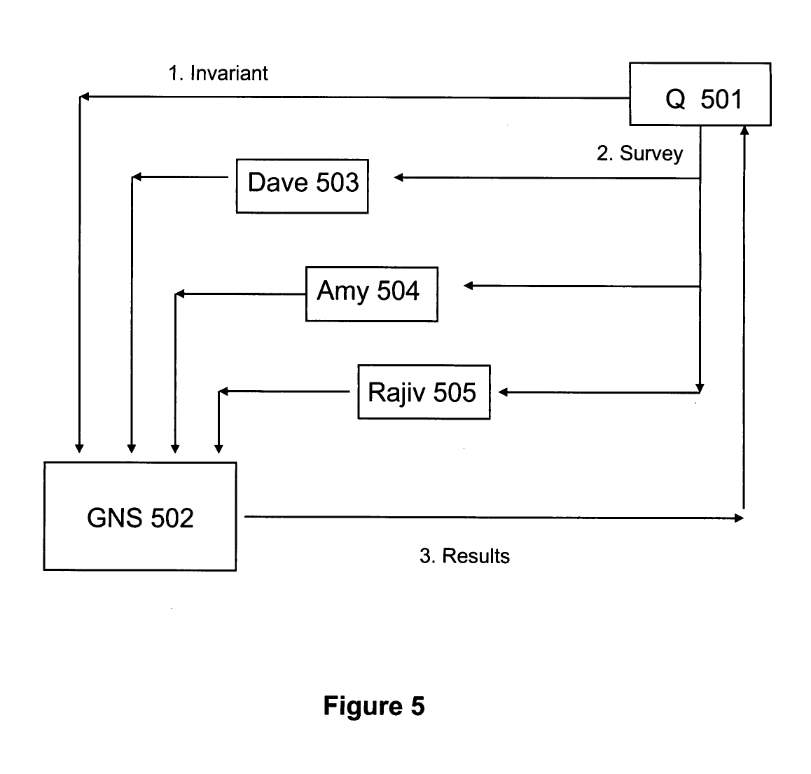

FIG. 5 shows an example. Q 501 in Step 1 sends to GNS 502 the invariant portion of a survey. In Step 2, Q 501 sends the survey to various respondents, like Dave 503, Amy 504 and Rajiv 505. They fill them out and forward these to GNS 502. The latter can then forward these to Q 501, along with summary geographic information about the respondents' locations.

This assumes that Q's users who take part in the survey trust the GNS not to reveal their addresses. The GNS is considered to be a well known, reputable entity. Notably, Q's users do not have to assume that Q is as well known or reputable as the GNS. This gives Q access to reliable information, without having to depend on the unknown veracity of self reporting by its users to Q directly.

Note that the above is susceptible to attack. If somehow a hostile third party were to find the text of that message by Q, then it could email copies to the GNS, where the senders of these messages are faked to be various sender addresses for the GNS occupants.

There are countermeasures. The first is simply what is the motive for the hostile party, if there is no direct financial gain to it? This is not so much a countermeasure as a statement of how likely the attack is.

A technical countermeasure is this. Q can send to each of its users a message that has two parts. One part is the same across all messages. This part is also first sent to the GNS, so that it can detect all messages with this part. The second part is unique to each recipient. It has a uniquely generated code. Prior to Q emailing its users, it tells the GNS the set of all valid code values. Q keeps a table of {(recipient's email, code)}. One implementation is that the set of valid code values is represented in functional form, as opposed to explicitly spelling out all valid values.

When a recipient forwards a message to the GNS, the GNS checks the code in the message against its table of valid codes. If the code is not in the table, it could be from a hostile, and the message is dropped. If the code is in the table, the GNS records the neighbourhood, as earlier. But it also pulls out the code and keeps this in a bin that holds all such received codes. This also guards against a replay attack, where the hostile has gotten a copy of one message, and made duplicates and sent these from other addresses to the GNS.

After some time, the survey is closed. The neighbourhood statistics are sent to Q, as before. In addition, the bin is sent to Q. Hence Q can find out which of its recipients answered the survey. Q can then reward those in some manner, without having to know where they live. The GNS can also sent Q information about detected false messages.

The above second method is more robust against attack than the first. And the personalisation lets Q offer incentives for its users to take part in the survey. The method is vulnerable against an attacker somehow detecting a message, copying it and sending it to the GNS before Q's recipient has done so. But in practical terms, it is much harder for the hostile to bias the survey for two reasons.

First, it would have to send the first copy of a message to the GNS. If it somehow can sniff a message en route from a user to the GNS, then that message will likely reach the GNS first.

Second, it would have to send the first copies of messages from recipients at many different email servers. Much harder than somehow breaking into one email server.

Another arrangement is for the GNS to generate codes in messages that will be sent to GNS recipients. By prior agreement with Q, Q tells the GNS what regions it is interested in surveying. Q might also specify other criteria about the respondents. If the GNS has access about these criteria, it can use these to filter. The GNS sends to recipients in those regions. There could be a parameter so that instead of all recipients that satisfy some criteria, only a subset is chosen by the GNS. This choosing could be done randomly.

For finer resolution, the codes might have information about which neighbourhood the recipient is in. When a recipient gets the message, it is from a trusted source. And the recipient might be able to send this message to Q from an arbitrary email address.

When Q gets such a message, the sender need not necessarily be already known to Q. Which could be an advantage over Q having to first amass a mailing list. Q is told by the GNS how to find the neighbourhood from the code in the message.

One variation is when replies from the respondents go first to the GNS, which might then modify them in some way, like stripping away the respondents' email addresses, before forwarding to Q. Perhaps this extra work by the GNS would entail a larger fee to Q than when the respondents correspond directly with Q.

Another variation is where Q asks its users to send it confirmation that they are in some region, perhaps to get a prize or discount on a purchase. If a user lives in that region, he communicates with the GNS. It gives him a code which he forwards to Q, from the email address that he is registered under in Q. By prior arrangement between the GNS and Q, the GNS might be expecting such queries. It tells Q how to decode the codes, to find the neighbourhoods. To reduce the chances of spoofing, the GNS might make each code unique and send the set of all generated codes to Q. So that Q will only record replies with codes in this set.

Or, the GNS could contact Q with the neighbourhood for that user.

More generally, the GNS might have a standard neighbourhood encoding method, which it might publicise, without having to do this specifically for each Q.

Another simple application could be verification of part of a user's identity at Q. (This could be considered a survey of one.) Q might send its user a code. The user then sends this to the GNS, in a message saying that it needs a reference from the GNS that the user is known. Possibly, this reference has some encoding for the user's location. Then, at some later time, Q asks the GNS, and presents the code. The GNS then replies saying that it has a user who submitted that code, and who lives in some neighbourhood. Depending on various circumstances, the GNS might reveal more information about the user.

One variant is that the GNS sends a message to Q with data. If it is by standard email, there is danger of spoofing. But this might be considered acceptable under some circumstances.

For all the methods in this section, the GNS might charge Q for its services.

In the above, we deliberately avoid having Q, its users and the GNS communicate via secure means, possibly involving PKI. The above steps are simpler, lightweight and assume only the use of standard email.

Another surveying method is to modify or use existing assessments of individuals at verified locations. Imagine a credit card company or other financial firm that already knows a person at an address. Here the verification of the address provided by the GNS might be moot to the firm, because it already has sufficient assurance of the person's address. Suppose the firm already has a credit rating for the person. Over all such persons, the firm uses the GNS to find associated web pages or domains.

Thus it can look to see if certain web pages or domains, or classifications of those items, are correlated with the credit ratings. Does a low credit rating associate with certain types of websites, where the latter indicate people's interests or habits? Leaving aside a possibly difficult question of causality, any correlations found could be used as stochastic indicators for, say, a new person, who has no credit rating, but who is in the GNS database and associates to certain domains.

Or, suppose the GNS lets a person hide various data about themselves. Then by surveying across many people, and looking at what types of data are revealed and what are hidden, there might be indicators of a person's values with regard to privacy. For example, a person who opts to reveal only the minimum amount of information might be more receptive to products that monitor her credit rating and reports made about her transactions to the ratings firms.

Another usage of the GNS could be for a census. Typically, a census is done at long intervals by a government. The sheer cost might be one reason. A census is often comprehensive; i.e. everyone is counted. And often a census associates each person with an abode, with varying degrees of anonymity about this mapping, where the variation is between countries. Hence the availability of a validated GNS offers the possibility of more frequent census taking.

A possible drawback is that the GNS does not include everyone in a nation or region. So the sampling might be statistical. There are serious issues here about the validity of results inferred from such sampling. But even so, the GNS offers rapid sampling. Especially if the GNS data has various electronic addresses of people, so that the sampling might be done using these, and so perhaps be cheaper than in-person interviews.

The GNS could let a company turn off surveying by all other entities in a given region. In a related manner, a company might obtain exclusive surveying rights, for a given amount of time, for a given region.

The region could be given by a postal code, a telephone area code or some kind of geofence-defined perimeter. For the latter, the GNS might define a region, or it might let a company define a region.

The exclusiveness might be only for person in that region who have certain interests or are in certain occupations, where it is assumed that the GNS has access to this information about the people. Or the exclusiveness might be for people who have told the GNS that they will let it define exclusive access to themselves, for some period of time.

A company might obtain exclusive access for any combination of {a period of time, a region, an interest or occupation of a respondent} by bidding for this at the GNS. Where the GNS could conduct auctions selling off such rights. The exclusiveness might involve the company offering special or extra compensation to respondents, compared to a company that contacts them via the GNS in a non-exclusive manner.

The GNS could have different policies for different regions that it covers. In some regions it might not permit any such exclusive access, while in other regions it might do so.

Even without a third party like Q, the GNS has access to valuable information from the queries it gets. Consider a query about a given (x, y) that arrives at the GNS over the Internet. It can come from a user with a cellphone at or near (x, y) or from a user with a computer at some other location, who is browsing the Internet. Even if the GNS cannot distinguish these cases, it can assume the former.

This gives it access to information about users' locations comparable to what a cellphone operator has. The latter might use these to send ads to the cellphone, where the ads are chosen in part or mostly based on the current location. Note that this has nothing to do in general with the Internet.

But for companies with servers on the Internet, a problem has been how to get real time information about users' current locations? The closest approximation has been to get the location of a user's Internet address. As explained earlier, this is crude. Fundamentally, an Internet company cannot get the same level of accuracy as a cellphone operator. Hence the ability of the company to geographically customize ads in web pages is weaker.

However the GNS has comparable accuracy as the cellphone operator. Hence it can deliver ads in the returned pages that use this geolocation information. Plus, at a collective level, it can provide aggregate information about location trends just as a phone operator might. Few other Internet companies can do this, which can make the GNS valuable to advertisers.

Effectively, the GNS can break the monopoly of a cellphone operator as far as users' locations are concerned. If the cellphone contacts the GNS via a non-cellphone network, then the operator cannot prevent a query to the GNS. Then suppose the cellphone contacts the GNS via the cellphone network. In principle, the operator could censor this; it is trivial to blacklist the GNS by parsing the Internet queries. However in some countries this might not be allowed. The operator might have to treat all queries equally.

Consider a (standard) website that might have a counter which shows how many people have visited a page (or the entire website). This refers to visits by browsers. Now consider a page returned by the GNS, for a given location or person at that location. It also can have a counter. But now the counter could primarily refer to physical visitors. If the GNS can distinguish from the queries it gets which are from general remote browsing and which are from physical browsing, then it can display two counters.

Consider a counter (and its affiliated data) that refers to physical browsing. Unlike normal web counters, this can be useful to advertisers. Both for a given location and for nearby locations. For example, in lieu of a simple count, the GNS might return maps and tables that show the number of physical visitors (over some time interval) to locations in a neighbourhood. This might be also be partitioned by time of day or day of the week. It gives a business an idea of the traffic near a location. The business can use this to determine staffing levels (e.g. increased during times of high traffic), as well as to find a location for a store.

Using the GNS in this manner might be more cost effective than having the business conduct its own onsite surveys of traffic.

Also, the queries to the GNS are more than just a simple count of physical traffic near a location. The queries signify to some extent that users are interested in a location. This can be enhanced if the GNS has some measure of how many users click on links in pages returned by the GNS. Links that are to ads might go first to the GNS, so it has extra measures of users' interests.

In Section 16, we pointed out that many queries are expected to be local, and that GNS hardware can thus be distributed in a simple manner to improve the response time to these queries. This has another consequence. In Section 1, we described how the GNS returns a web page for a user at a location that shows links to non-GNS sites, provided by the user. The quick response could mean that a tradeoff could be made, where those links go first to the GNS, which then redirects to the user-intended destinations. This increases somewhat the workload on the GNS server and the response time seen by the user. But this might be acceptable, and it gives the GNS more information about visitors and how they respond (i.e. clickthrough) on a user's links.

If the GNS cannot distinguish between remote and local queries, then the above can still be done, albeit with some diminished efficacy.

19. Application Programming Interface (API)

The GNS can publish an API that lets third parties use or extend its services.

As an example, consider company Q in the first example of Section 18. Q wants to know the neighbourhood distribution of its users. Q might sign up via the API. There could be some preliminary manual or programmatic steps, where the GNS investigates Q for its bona fides. Assume that Q passed these steps.

The API has methods for conducting a survey. Q uses this to submit text in messages that it will send to its users. Q also tells the GNS when the survey will start and end. Then when Q sends copies of the message, the GNS will be instructed to do the steps in Section 18 to count up respondants in each neighbourhood.

The automated steps could include means for Q to pay the GNS.

It should be understood that the methods are well defined enough to be easily implemented or controlled via an API.

20. Searching

The GNS enables searching across new types of data that current search engines might not have access to. Most search engines focus on spidering and analysing web pages. The GNS has the ability to offer searching by owner or occupant name, at least to the extent that these are publicly searchable. The association between these and a location might not exist in any web page. We might consider these “forward” searches, inasmuch as they follow the order of Steps A-C.

The physical proximity of various data, like the names of several occupants of different locations, is also a powerful search tool. One that simply seems unavailable from analysis of web pages. There could be search parameters based on the distances, minimum or maximum, of various people from each other.

Another advantage is the potential accuracy of the data. Web pages can be written by arbitrary contributors and there is little, per se, to vouch for the accuracy of any given web page. While there might seem little, a priori, to say that pages written by authors at known locations are inherently more accurate, the study of this very issue can be fruitful. Especially if it suggests that the latter pages are indeed more accurate or informative.

Another domain of GNS searching is temporal. A history of the owners of a location or the occupants of that location, with possibly dates attached, extends the search ability.

The web pages given by the occupants are also a rich source of correlations with location. By themselves, the web pages could be analysed in conjunction with other web pages, in a manner likely done by a standard search engine. But now we also have physical proximity of the localised pages. So pages from the same neighbourhood can be mined for clues about the professional and personal interests of that district. In turn, this can aid stores in the district, or stores planning to move into the district.

Nor are these static views. The changing results over time can give clues about the uptake and decline of trends, all spatially localised. It also gives a way to detect districts where trends start, or even individuals involved in this process, i.e. trendsetters.

Another possibility is analogous to how links in web pages are unidirectional. A page that is linked to in general does not know what pages link to it. A lot of the utility of search engines is based on finding this information. Likewise, pages pointed to by links in GNS results will not know the locations these come from. This information could be termed a “reverse” search, since it goes in the opposite direction to Steps A-C.

So the GNS could have a search page. There is a box where the user can type a URL. The reply is the set of locations and entities at those locations that link to the URL, if any.

Here, the page at that URL need in general have nothing in it to a priori associate with those locations and entities. Notice however that this is a manual query by a user, who has to type or paste in a URL.

How can this be extended to a programmatic check of a webpage at some URL? Note that the steps in the previous paragraph can simply be extended to where the GNS accepts a query and replies, perhaps in XML, with the results. This is a data service provided by the GNS. So this can be automated. The problem now shifts to the query side. Imagine a person browsing. She would like to check if a page has those geographic associations.

One way is with a modified browser, with a button. Pressing it makes the browser ask the GNS using the automated method. So the user doesn't have to copy the browser's current URL, go to another browser instance, go to the GNS query page, paste the URL and see the result. Still, the problem remains that on what basis should the user check her browsing pages? She can do this for every page, but that is too manually intensive.

Suppose a webpage has a custom tag like <gns_check/>. A modified browser can check this. It asks the GNS if the URL for this page is in the database. If so, then it can, for example, change the colour of a custom button on the browser, to indicate that the page is GNS-verified. Possibly, the button could have an option to let the user see the location and other data about the page in the GNS database.

Or suppose a webpage has a location, like a geofence, written in it, possibly in custom tags whose meaning is known to the GNS. Here the custom (i.e. non-HTML) tags will usually mean that the contents of the tags are not displayed in a normal browser. The browser then asks the GNS if the URL for that page is in the GNS database, and if the location in that database is the same as the location in the page. If so, then as before, the result is indicated in the browser.

An extension of the previous paragraph is for the custom tags to also include the person or entity that linked to the page shown in the browser. If this verifies with the GNS, the browser could also show the verified entity in a popup window, for example.

The custom tag gives a bidirectional link between a page at an address and a location or entity at that location. This bidirectional works around the intrinsic unidirectional nature of standard HTML links. Also, if results verify, it also says that at least one party, known to the GNS, can modify the page at a given URL. This is stronger than the general case where an entity could specify an arbitrary URL, without having any write ability for the URL's page.

In the steps of the previous 4 paragraphs, if the custom tag does not validate, then this could also be shown by a different colour of a custom button. And perhaps the links and buttons in the page could be turned off, to protect the user from a possible fake page.

When a custom tag is used, a possibility is that the tag is invalid, but that it was once valid. This could be seen as different from where a tag was never valid. This case of a previously valid tag could be indicated in some manner in the browser, distinct from a never valid tag.

In the case where the custom tag can include a location and user, the possibility also arises where it could include several locations and users, that link to the page. The verification might find that only some of these are valid, and indicate this in some fashion in the browser. Perhaps by a popup window that shows the valid and invalid results. Likewise, there could also be a distinction between an invalid result that was once valid and a never valid result.

The ability of a search engine to do this reverse searching will also give it another dimension in which to evaluate the pages. Which may aid whenever those pages are returned in a group of results to a general search query ostensibly unrelated to location or a GNS. Pages pointed to from GNS results might be considered more reliable than pages that are not, all other factors being equal.

21. Digital Storage

The GNS is a trusted entity that verifies data associated with a location. Given this, a natural business for the GNS is to act as a storage of digital documents associated with a location or with an individual or organisation associated with that location.

The documents might or might not be encrypted. If they are encrypted, the GNS could possess a key to decrypt. Or there could be layers of encryption of a document, and the GNS could be able to decrypt only one layer.

Or the documents might be keys. These could be used to encrypt and decrypt documents held external to the GNS.

One type of document that could be stored is digital title deeds to the property, and tenant contracts. The storage of these with the GNS need not be obligatory. But the convenience of the GNS may make it useful.

When the GNS returns results for an entity at a location, the results could also include the public key of a public and private key pair. Hence a user could use this for PKI authentication or encryption of communication with that entity.

22. No GNS

In Section 1d, we described using a search engine to look for “Mike Wong”. The many results represent different persons with that name. Person files were used, in conjunction with the GNS, to disambiguate the results, by partially grouping around specific persons of that name.

Now suppose a GNS does not exist. Let there be a central website. This lets a user search for a given person, e.g. “Mike Wong”, and see links to web pages on other domains that reference him or were written by him. A specific Mike Wong might have an entry written by him. It could give a partial address, e.g. “Chicago Ill. USA”. Plus, it might have one or more keywords indicating profession or company, e.g. “singer, taxi driver”. So the name, partial address and keywords could be one line in a table of Mike Wongs.

If we click on a line, this brings up another page. This can have more details about the person. Plus a photo, and links to various contact addresses, like email and phone number. There can also be links to domains owned by him.

The page also shows two links—“by me” and “about me”. The former brings up a page of URLs of pages written by the person. These could be at various websites. The latter brings up a page of URLs of pages that mention the person.

In both pages, by each URL could be a short remark commenting on it.

The intent of the domain is to provide a central location where a person can define which web pages are actually about him or by him. The populating of the database would be mostly done by individuals who want to define all the desirable links about themselves on the Web. Like Wikipedia, contributions could be solicited. There would be a panel of editors, with the ability to arbitrate disputes about edits.

One revenue source would be by individuals who want to lock down the editing of “their” pages to only themselves (and the editors). A priori, anyone could author a page about a new person, who does not need to be the author.

The website skirts the current Wikipedia policy about the inclusion of individuals. Basically, a determination is made by the Wikipedia editors if a person is sufficiently well-known to warrant inclusion. If not, then the entry is removed. In contrast, our website would explicitly not have this as a consideration.

In terms of privacy, concerns about a GNS data are largely avoided here. Individuals decide how much information about themselves to write.

A major use of the website could be by a search engine. If it gets a query string, it can ask the website if it has anyone by that name. If so, then the data per person by the website, for all persons with that name, can be used by the search engine, to offer clustering of its results.

Can't a person just have his own personal website? That is possible. But there are two considerations. Imagine you are a given Mike Wong. Perhaps mikewong.com is already taken by someone else. So if you make your own website, how obvious is that for others to find? Plus, there might be many pages about you, scattered over the web. All these are returned by the search engine, commingled with pages for others with your name. On your own website, you can certainly link to other pages at other domains that are about you. But in general most people who have their own domains can't be assumed to do this, or to do it in a format that can be programmatically deduced by a search engine.

Whereas the central website, if it is popular enough, then by having a regular structure to its pages, that cluster links by individuals, then a search engine can use this data. The website might make its data available for this purpose as a data feed, rather than have the search engine scrape its pages.

For people who wish to network professionally, there are various social networking sites. But these generally have very limited links to external sites. Most of the “links” in those sites are between persons. This is what social networking means. Our central site essentially has unrestricted numbers of domain links per person.

If the website becomes popular enough, it can act as a holder of de facto personal websites for many individuals; in lieu of them having to maintain their own, separate domains.

The closest approximation to the method of this section seems to be Google Profiles. But an inspection of those reveals that most participants only link to a few websites. Typically such websites are their own personal ones or their workplace domains. Rarely does a person link to pages at sundry domains that mention her, where those domains are not of the types in the previous sentence.

The main difference between the website and the use of the GNS in the bulk of this invention is that there is no independent authoritative body that verifies the data. And there is no mapping from an (x,y) to a person.

Another approach also does not use the GNS. It involves the Locator website of Section 1e. Consider the example of a person file at the Locator, with an entry

<person>
<target> [URL] </target>
<from>Mike Wong</from>
<to> [person URL] </to>
</person>

The person URL uses a GNS. But suppose the GNS does not exist. The person URL can be replaced by a URL “strongly” associated with that specific person, like a personal website, or a webpage about that person at his workplace or organisation. Or it might point to a person in Google Profiles, say, where this treats a page in the latter as equivalent to a person's homepage.

The <to> field could also be generalised to some other network address (like an email address or phone number). There could be multiple <to> instances.

Then, by having multiple <target> instances, and possibly multiple <from> instances, a person's presence on the Web could be compactly described in a <person>.

This also lets a search engine use a Locator's database, if it is sufficiently populated, to provide clustering by individuals as described earlier.

23. Other Usages of a Person File

Suppose we now have many person files. Let each describes a single individual, with each file having several/many links to pages across the Web about or by that person. This can be with or without the use of a GNS.

A single file could then be used to spider the target URLs, and thence build up an understanding of that person's interests and activities. The simplest way would be to count up the tokens in those pages, and possibly map the tokens into various topics. The definitions of a topic in terms of tokens could be from various ontologies defined external to this invention.

The person file encodes information about the person written over a range of time. By being able to estimate the date when each URL first appeared, we can get some estimate if a person's interests or activities changed over time.

One usage is to input the person file into an artificial intelligence machine that makes a character that will be a simulation of that person, or of a person of similar interests. This assumes that the AI machine already has a database from which it can simulate aspects of a person's character, and so the person file, through its URLs, is used to draw from that AI database. Essentially by parameterising a person.

Let Theta and Rho be two person files, where the corresponding persons are different. We can define the intersection of Theta and Rho in various useful ways. One obvious way is to look for the “literal” overlap between the URLs in both files. At the simplest level, is there a web page present in both files that mentions both persons? If so, then there might be a pre-existing connection of some kind between the two persons. They might not necessarily know each other. A third person could have written the page.

At a higher level, we might look and count in some manner if any URLs in Theta and Rho share a common domain. This may be somewhat limited if (for example) that domain is a large social networking domain with many users of disparate interests.

For another approach, we could find the tokens and topics associated with Theta and Rho and find any overlap. Here, we are not expecting that the persons know each other. But perhaps they have common interests, or not. In different circumstances, both cases can be desirable.

For each type of intersection, we could define a metric. In general, for a person file, there could be two classes of metrics. One measures geographic distance, using GNS data, if it is available. If not, then following the discussion of the previous section, an approximate geographic distance could be found, using approximate locations of the persons. The other class of metric would be for the intersections of the persons' URLs, which we take to be a measure of the intersections of the persons' interests.

We can define a <group> of several <person>. All the remarks about the interests of the individuals could pertain to the group. Here, we could sum up the tokens in the target pages across all the persons, and use this as an interest vector for the group. The group's topics could be found from the individuals' topics.

Given a set of {<person>} and a specific <person> not in that set, then the set could be searched for those closest to the latter. This can be used in an application where someone has an associated <person> and wants to find those others closest in interests to her. Social networking and dating domains are obvious websites that can use this data.

We claim:

1. A method comprising: A Geo Name Service (GNS) that accepts an electronic query containing a location, given in latitude and longitude, or a full street address, and which returns names of an owner or occupants of that location, where these can be individuals or organisations, along with related information including email addresses, Instant Messaging addresses, telephone numbers, and URLs, where the latter can be of web pages, entire domains or of data feeds.

2. A method of using claim 1, wherein a mobile computer, like a cellphone, can wirelessly query the GNS, using as input the computer's current location or that location plus some offset vector or orientation.

3. A method of using claim 1, wherein the GNS also stores verified biometric data, like fingerprints or retinal scans, as well as images of individuals.

4. A method of using claim 3, wherein the GNS accepts a query of a person's name and address and some biometric alleged to be of that person, and the GNS replies yes or no depending on whether this data is in the GNS database or not.

5. A method of using claim 1, wherein an augmented reality device carried by a user, that displays scenes, overlays these with results from the GNS, that correspond to the locations shown in the display.

6. A method of using claim 1, wherein the GNS has data from an onsite inspection of a location for an inventory listing, and makes the data available to queries about that location, as a data feed coming directly from the GNS; and where the GNS can accept a query with an item's serial number and return the location of the item.

7. A method of using claim 6, wherein an item has Digital Rights Management (DRM) software controlling its access, where the DRM asks the GNS with the item's serial number for the item's location, and the DRM compares this against logic for valid locations, to lock or unlock the item.

8. A method of using claim 7, wherein if the GNS returns the date when it did the inventory, the DRM can refuse to unlock the item if the date is too far in the past, according to some internal DRM setting of valid date ranges.

9. A method of using claim 1, wherein the GNS obfuscates some contact information for an entity, by substituting a contact address maintained by the GNS, and whereby any messages received by the GNS are forwarded to an actual contact address of the entity, and replies by the entity go through that GNS contact address.

10. A method of using claim 1, wherein a firm sends a copy of part of a message to the GNS; then sends messages with that copy to a mailing list; where recipients who are in the GNS database forward these to the GNS; where the GNS detects such messages containing the copy; where the GNS makes a table of number of replies per neighbourhood; where the GNS sends the table to the firm, as a geographically verified survey.

11. A method of using claim 10, wherein the firm also sends the GNS a set of valid codes, or a function to make such a set; where these codes are put into messages sent to the firm's mailing list; where the GNS checks incoming messages for both the copy and the valid code; where the GNS sends to the firm the valid codes it has received, so that the firm can find which of its recipients answered its query or survey.

12. A method of using claim 1, wherein a firm asks the GNS for users in some region, possibly with other criteria; where the GNS applies these constraints and sends messages to those in the region, where the messages have codes designating neighbourhoods within the region; where the recipients forward the messages to the firm; where the firm decodes the codes to find recipients in verified neighbourhoods, without knowing the actual addresses of the recipients.

13. A method of using claim 1, wherein a firm asks a person to prove she is in a neighbourhood, without her having to disclose her full address; where the person is in the GNS database and asks the GNS for a code for the neighbourhood; where if the person is in the neighbourhood, the GNS supplies the code and an id of the person to the firm.

14. A method of using claim 1, wherein a firm sends a person a unique code; where if the person is in the GNS database, she forwards the code to the GNS; where the firm contacts the GNS with the code; where the GNS replies with the neighbourhood that the person is in.

15. A method of using claim 1, wherein a data feed is of a location's inventory of goods or services available for sale to or purchase from a visitor.

16. A method of using claim 1, wherein the data includes a history of previous owners and occupants of a location, optionally with current contact information.

17. A method of using claim 1, wherein a “person file” is defined, with mappings, where the key is a text string that represents a person's name, or the key is an address of an image file, optionally including a demarcation of a subset of that image, or the key is an address of a video file, optionally including a demarcation of subsets of the file's images;
and the value is a “person URL” that points to an address at the GNS of a page describing a location and a person associated with that location.

18. A method of using claim 17, wherein a web page explicitly includes a person file, or a set of web pages with a common prefix directory address implicitly use a person file referenced by that same prefix address.

19. A method of using claim 17, wherein a browser uses a person file to modify a web page under display, by making links from strings or images in the page or subsets of images in the page, that are in the person file as representations of persons, where the links use as destinations the corresponding person URLs defined in the person file.

20. A method of using claim 17, wherein a search engine uses person files to distinguish search results for a person, by grouping the results by any associated person URLs.
